(19) United States
(12) Patent Application Publication
(10) Pub. No.: US 2011/0054133 A1
(43) Pub. Date: Mar. 3, 2011

(54) RESIST POLYMER, PREPARING METHOD, RESIST COMPOSITION AND PATTERNING PROCESS

(75) Inventors: Seiichiro Tachibana, Joetsu-shi (JP); Kenji Funatsu, Joetsu-shi (JP); Takeshi Kinsho, Joetsu-shi (JP); Tsunehiro Nishi, Joetsu-shi (JP)

(73) Assignee: SHIN-ETSU CHEMICAL CO., LTD., Tokyo (JP)

(21) Appl. No.: 12/940,511

(22) Filed: Nov. 5, 2010

Related U.S. Application Data
(62) Division of application No. 11/797,683, filed on May 7, 2007.

(30) Foreign Application Priority Data
May 12, 2006 (JP) 2006-133797

(51) Int. Cl. C08F 224/00

(52) U.S. Cl. 526/270; 526/266

(57) ABSTRACT

A polymer for resist use is prepared by previously charging a reactor with a solution containing a chain transfer agent and holding at a polymerization temperature, and continuously or discontinuously adding dropwise a solution containing monomers and a polymerization initiator to the reactor for radical polymerization. The polymer has a minimized content of a substantially insoluble component. A resist composition using the polymer as a base resin produces a minimized number of defects when processed by photolithography and is useful in forming microscopic patterns.

### CROSS-REFERENCE TO RELATED APPLICATION

This application is a divisional application of U.S. patent application Ser. No. 11/797,683 filed on May 7, 2007, which claims priority under 35 U.S.C. §119(a) on Patent Application No. 2006-133797 filed in Japan on May 12, 2006, the entire contents of which are incorporated herein by reference.

### TECHNICAL FIELD

This invention relates to (i) a polymer for resist use, (ii) a method for preparing the polymer, (iii) a resist composition comprising the polymer as a base resin for use in the micropatterning technology, and (iv) a patterning process using the resist composition.

### BACKGROUND OF THE INVENTION

In the recent drive for higher integration and operating speeds in LSI devices, the pattern, rule is made drastically finer. Deep-ultraviolet lithography is believed promising as the next generation of microfabrication technology. In particular, photolithography using an ArF excimer laser as the light source is strongly desired to reach the practical level as the micropatterning technique capable of achieving a feature size of less than or equal to 0.3 μm.

For chemically amplified resist compositions adapted for photolithography using an excimer laser, especially ArF excimer laser of 193 nm wavelength as the light source, (meth)acrylate polymers which are transparent at that wavelength are known from JP-A 4-39665. Most (meth)acrylate polymers contain recurring units having a group (i.e., acid-labile group) capable of reacting with an acid to yield a polar group which is soluble in alkaline developer, and recurring units having a polar group for ensuring adhesion to a semiconductor substrate, especially lactone structure (see, for example, JP-A 9-73173 and JP-A 9-90637).

These (meth)acrylate polymers are generally prepared by solution polymerization processes. In particular, a so-called dropwise polymerization process is often employed wherein monomers, a polymerization initiator and optionally, a chain transfer agent are fed in admixture or separately to a polymerization solution at a polymerization temperature (see, for example, JP-A 2004-269855 and JP-A 2004-355023). The dropwise polymerization process is believed suitable for the preparation of resist-use polymers since polymers having a not so considerably biased polymerization composition are available.

The polymers prepared by the dropwise polymerization process, however, are not regarded as having a fully uniform composition. Due to the difference in polymerization reactivity between monomers, the composition of the polymer being formed differs between the initial and late stages of polymerization. Particularly when a (meth)acrylate having a polar group such as a lactone structure-containing group and a (meth)acrylate having an acid-labile group are copolymerized, the polymer formed at the initial stage contains a larger proportion of recurring units having polar groups. While the polymerization composition of a polymer affects the solubility of the polymer in a resist solvent, a polymer containing an excess of polar group-containing recurring units is less soluble in the resist solvent.

When copolymerization is performed by the dropwise polymerization process, a polymer formed at the initial stage of polymerization has a higher molecular weight than those polymers formed at the intermediate and late stages of polymerization. This is probably because more (meth)acrylate having a higher polymerizability polymerizes at the initial stage, and the ratio of monomer concentration/radical concentration at the initial stage is higher than those at the intermediate and late stages. The solubility of a polymer in a resist solvent also depends on the molecular weight. The higher the molecular weight, the lower becomes the solubility.

Specifically, at the initial polymerization stage of the dropwise polymerization process, there prevail reaction conditions under which a polymer being formed is likely to incorporate recurring units having polar groups and build up its molecular weight, so that a fraction having least solubility in the resist solvent may form in a trace amount. Then, in a resist composition using the polymer prepared by the dropwise polymerization process as a base resin, an insoluble matter of minimum size is present. This insoluble matter can cause development defects in the photolithography.

While the pattern rule is made finer and the quality management with regard to photolithography defects becomes severer, there is a strong demand for a base resin for use in resist compositions which does not produce defects in lithography and a method for preparing the same.

### DISCLOSURE OF THE INVENTION

An object of the invention is to provide a polymer for use in resist compositions having a minimized content of a component which is substantially insoluble in a resist solvent, and a method for preparing the same. Another object is to provide a resist composition comprising the polymer which yields minimal development defects when processed by photolithography using radiation having a wavelength equal to or less than 300 nm, especially ArF excimer laser light, and a patterning process using the resist composition.

The inventors have found that a polymer having a minimized content of a component which is substantially insoluble in a resist solvent is obtainable by proper use of a chain transfer agent during radical polymerization; and that when a resist composition comprising the polymer as a base resin is processed by photolithography using a light source of a wavelength equal to or less than 300 nm, the number of development defects is minimized. Thus the composition is quite effective for precision microprocessing.

Accordingly, the present invention provides a resist-use polymer, a polymer preparation method, a resist composition, and a patterning process, which are defined below.

[1] A method for preparing a polymer for resist use, comprising the steps of:

previously charging a reactor with a solution containing a chain transfer agent and holding at a polymerization temperature, and

continuously or discontinuously adding dropwise a solution containing at least one monomer and a polymerization initiator to the reactor for radical polymerization.

[2] A method for preparing a polymer for resist use, comprising the steps of:

previously charging a reactor with a solution containing a chain transfer agent and holding at a polymerization temperature, and

continuously or discontinuously adding dropwise a solution containing at least one monomer and a solution containing a polymerization initiator separately to the reactor for radical polymerization.

[3] The method of [1] or [2], wherein the chain transfer agent is a thiol compound.
[4] The method of [3], wherein the chain transfer agent is selected from the group consisting of 1-butanethiol, 2-butanethiol, 2-methyl-1-propanethiol, 1-octanethiol, 1-decanethiol, 1-tetradecanethiol, cyclohexanethiol, 2-mercaptoethanol, 1-mercapto-2-propanol, 3-mercapto-1-propanol, 4-mercapto-1-butanol, 6-mercapto-1-hexanol, 1-thioglycerol, thioglycolic acid, 3-mercaptopropionic acid, and thiolactic acid, and mixtures thereof.
[5] The method of any one of [1] to [4], wherein the polymer prepared by the method comprises recurring units derived from an acid-labile group-containing monomer and recurring units derived from a lactone structure-bearing monomer.
[6] A polymer for resist use, prepared by the method of any one of [1] to [5].
[7] A resist composition comprising the polymer of [6].
[8] A process for forming a pattern, comprising the steps of applying the resist composition of [7] onto a substrate to form a coating; heat treating the coating and then exposing it to high energy radiation having a wavelength of up to 300 nm or electron beam through a photomask; and heating treating the exposed coating and developing it with a developer.

As described above, in the dropwise polymerization process generally used for the preparation of base resins for resist compositions, such reaction conditions prevail at the initial stage of polymerization that a polymer being formed tends to have a biased composition and build up its molecular weight. Thus a component which is substantially insoluble in a resist solvent is formed in a minute amount at the initial polymerization stage. This substantially insoluble component can manifest as defects in the photolithography.

The inventors presumed that a base resin having a less content of a component which is substantially insoluble in a resist solvent would be obtained by ameliorating the reaction conditions at the initial stage of the dropwise polymerization process. In view of the fact that the solubility of a polymer in a solvent depends on its molecular weight, the inventors presumed that it would be effective to reduce the molecular weight of a polymer being formed at the initial stage. On the basis of this presumption, radical copolymerization was carried out by a procedure of feeding a monomer and a polymerization initiator to a reactor which had been charged with a chain transfer agent solution and held at a polymerization temperature. Then a base resin having a minimal content of a component which is substantially insoluble in a resist solvent was obtained as intended. The present invention is predicated on this finding.

Problems associated with the dropwise polymerization process are discussed. When only the solution to be added dropwise to the polymerization system contains a chain transfer agent, a large amount of chain transfer agent must be used in order to fully reduce the molecular weight of a polymer being formed at the initial stage. If so, then a polymer being formed at the end of polymerization has too low molecular weight. When such polymer is used as a base resin in a resist composition, no satisfactory pattern profile is obtainable. By contrast, the radical polymerization method of the invention is such that only a polymer being formed at the initial stage has a low molecular weight, and a polymer having an appropriate molecular weight for resist use is obtained at the end of polymerization.

Another method contemplated for reducing the molecular weight of a polymer being formed at the initial stage of polymerization is by previously charging a reactor with a radical polymerization initiator. Since this method allows the amount of initiator left in the reactor to vary depending on a difference of thermal hysteresis from the charging of initiator to the feed of monomers, the resulting polymer differs in molecular weight and dispersity between manufacturing lots. By contrast, the polymerization method of the invention eliminates the influence of thermal hysteresis and minimizes the variation of molecular weight and dispersity of polymers between manufacturing lots.

As understood from the foregoing, the resist composition comprising the polymer prepared by the method of the invention as a base resin contains a minimized amount of substantially insoluble component and yields a minimized number of development defects when processed by photolithography. It is thus quite useful in forming microscopic patterns. In addition, the polymerization method of the invention minimizes the variation of molecular weight dispersity of polymers between manufacturing lots.

### BENEFITS OF THE INVENTION

The polymer prepared by the method of the invention has a minimized content of a component which is substantially insoluble in a resist solvent. When the polymer is used as a base resin in a resist composition, especially a chemically amplified positive resist composition adapted for photolithography with an ArF excimer laser as a light source, the resulting resist composition yields a minimized number of defects when processed by photolithography and is useful in forming microscopic patterns.

### DESCRIPTION OF THE PREFERRED EMBODIMENTS

The singular forms “a,” “an” and “the” include plural referents unless the context clearly dictates otherwise. As used herein, the terminology “(Cₓ-C_{y})”, as applied to a particular unit, such as, for example, a chemical substituent group, means having a carbon atom content of from “x” carbon atoms to “y” carbon atoms per such unit.

### Polymer

In one embodiment of the invention, a polymer for use as a base resin in resist compositions is prepared by charging a reactor with a solution containing a chain transfer agent and holding the solution at a polymerization temperature, and continuously or discontinuously adding dropwise a solution containing a monomer and a polymerization initiator to the chain transfer agent solution with stirring for radical polymerization.

In another embodiment of the invention, a polymer is prepared by charging a reactor with a solution containing a chain transfer agent and holding the solution at a polymerization temperature, and continuously or discontinuously adding dropwise a solution containing a monomer and a solution containing a polymerization initiator separately to the chain transfer agent solution with stirring for radical polymerization.

In the embodiment wherein a solution containing a monomer and a polymerization initiator is prepared, while the solution is added dropwise to a polymerization solution, the polymerization initiator can be decomposed to generate radicals with which polymerization proceeds so that a component which is substantially insoluble in a resist solvent may form. It is thus desirable that a solution containing a monomer and a solution containing a polymerization initiator be separately prepared and separately added dropwise.

Separate preparation of a monomer solution and a polymerization initiator solution is also preferred in that the monomer solution can be heated prior to dropwise addition to the polymerization solution. If the solution containing both a monomer and a polymerization initiator is heated, there is a likelihood that polymerization will occur prior to its entry into the polymerization solution. It is thus undesirable to heat the solution containing both a monomer and a polymerization initiator above room temperature.

If a solution at a low temperature is fed to the polymerization solution, the temperature of the polymerization solution is likely to lower, especially at the initial stage when the liquid volume of the polymerization solution is small and the heat of polymerization reaction is yet insignificant. Such a situation brings about a higher ratio of monomer concentration to radical concentration and results in a polymer building up its molecular weight, with a more likelihood of formation of a component which is substantially insoluble in a resist solvent. In contrast, if a monomer solution is heated, the temperature drop of the polymerization solution concomitant with the solution feed is minimized, suppressing the formation of a substantially insoluble component.

In the event where a solid monomer is used, if a monomer solution is at a low temperature, the monomer will precipitate out during dropwise addition of the solution to the polymerization solution. This can interfere with the feed operation.

For the reason described above, it is preferable to prepare a monomer solution and a polymerization initiator solution separately and to preheat the monomer solution prior to dropwise addition to the polymerization system. Preferably the monomer solution is preheated to a temperature of at least 30° C., and more preferably at least 40° C., but equal to or less than 70° C. for preventing polymerization by overheating.

On the other hand, the polymerization initiator solution is preferably heated at a temperature equal to or less than 40° C., more preferably equal to or less than 35° C., because the polymerization initiator can be degraded at too high a temperature.

Preferably the chain transfer agent used herein is a thiol compound. The reason is as follows. A small amount of the thiol compound is fully effective for reducing the molecular weight because propagating radicals in polymerization reaction are likely to pull hydrogen from the thiol. In addition, the polymerization yield does not decline because the radicals created after pulling of hydrogen from the chain transfer agent have a high polymerization re-initiation capability. Suitable thiol compounds include, but are not limited to, 1-butanethiol, 2-butanethiol, 2-methyl-1-propanethiol, 1-octanethiol, 1-decanethiol, 1-tetradecanethiol, cyclohexanethiol, 2-mercaptoethanol, 1-mercapto-2-propanol, 3-mercapto-1-propanol, 4-mercapto-1-butanol, 6-mercapto-1-hexanol, 1-thioglycerol, thioglycolic acid, 3-mercaptopropionic acid, and thiolactic acid. These thiol compounds may be used alone or in admixture of two or more.

The chain transfer agent which is previously charged in the polymerization reactor must be used in a larger amount as the difference in polymerization reactivity between a monomer having an acid-labile group and a monomer having a polar group becomes greater. This is because a greater difference in polymerization reactivity tends to bias a polymer composition. Unless the molecular weight is accordingly reduced, a component which is substantially insoluble in resist solvent will form. However, if the chain transfer agent is used in excess, the resulting polymer has so low a molecular weight that no satisfactory pattern profile is obtainable by lithography. For these reasons, the amount of the chain transfer agent which is previously charged in the polymerization reactor according to the inventive method is preferably 0.4 to 5.0 mol %, more preferably 0.5 to 4.0 mol % based on the total moles of monomers used.

In the method of the invention, a chain transfer agent may also be fed to the solution to be added dropwise to the polymerization solution, for the purpose of adjusting the molecular weight of the polymer available at the end of polymerization reaction. In addition to the pre-charge to the reactor, the chain transfer agent may be fed in an amount of 0.1 to 5.0 mol %, more preferably 0.1 to 4.0 mol % based on the total moles of monomers used, to the solution to be added dropwise to the polymerization system. It is noted that the chain transfer agent previously charged to the reactor and the chain transfer agent fed to the solution to be added dropwise may be the same or different.

The polymerization'initiator used in the method of preparing a resist-use polymer according to the invention may be selected from well-known radical polymerization initiators. Suitable initiators include, but are not limited to, azo compounds such as 2,2′-azobisisobutyronitrile, 2,2′-azobis-2-methylisobutyronitrile, dimethyl 2,2′-azobisisobutyrate, 2,2′-azobis-2,4-dimethylvaleronitrile, 1,1′-azobis(cyclohexane-1-carbonitrile), and 4,4′-azobis(4-cyanovaleric acid), and peroxides such as lauroyl peroxide and benzoyl peroxide. The initiators may be used alone or in admixture of two or more.

If the amount of polymerization initiator used in the inventive method is too small, the yield of polymerization reaction may become low. If the amount is too large, the polymer may have too low a molecular weight, failing to form a satisfactory pattern profile when processed by lithography. Therefore, the amount of polymerization initiator used is preferably 0.1 to 10.0 mol %, more preferably 0.3 to 8.0 mol % based on the total moles of monomers used.

The solvent used in the polymerization step of the inventive method, including the solvent in which the chain transfer agent to be pre-charged to the reactor is dissolved, and the solvent of the solution to be added dropwise to the polymerization system, may be any desired solvent as long as the monomers, polymerization initiator, chain transfer agent, and product polymer are dissolvable therein. Suitable solvents include, but are not limited to, hydrocarbon solvents such as benzene, toluene and xylene; glycol solvents such as propylene glycol monomethyl ether and propylene glycol monomethyl ether acetate; ether solvents such as diethyl ether, diisopropyl ether, dibutyl ether, tetrahydrofuran and 1,4-dioxane; ketone solvents such as acetone, methyl ethyl ketone, methyl isobutyl ketone, and methyl amyl ketone; ester solvents such as ethyl acetate, propyl acetate, butyl acetate and ethyl lactate; and lactone solvents such as γ-butyrolactone.

The solvent of the chain transfer agent solution to be pre-charged to the reactor and the solvent of the solution to be added dropwise to the polymerization solution each may be a single solvent or a mixture of two or more solvents. The solvent in which the chain transfer agent is dissolved and the solvent of the solution to be added dropwise to the polymerization solution may be the same or different. In the embodiment wherein the monomer solution and the polymerization initiator solution are separately added dropwise, the solvents for these solutions may be the same or different.

Notably, in the event the monomer(s) is liquid, a solution of the polymerization initiator and optionally the chain transfer agent in the monomer may be added dropwise to the polymerization system. Alternatively, the monomer and a solution containing the polymerization initiator and optionally the chain transfer agent may be separately added dropwise.

In the event the polymerization initiator is liquid, a monomer solution and the polymerization initiator or a mixture (solution) of the chain transfer agent and polymerization initiator may be separately added dropwise.

The concentration of the solution to be added dropwise to the polymerization solution is not particularly limited. In the event the initiator and monomer(s) used are solid, it is necessary to select such a concentration that they will not precipitate during the process. In general, the total concentration of monomers is preferably 10 to 70% by weight and the concentration of polymerization initiator is preferably 5 to 60% by weight, although the exact concentration varies with the identity of solvent, initiator and monomers.

The amount of the solvent in which the chain transfer agent to be pre-charged to the reactor is dissolved must be an amount that allows for stirring in the reactor used. In general, the amount of the solvent is 25 to 500% by weight based on the total weight of monomers used.

The polymerization temperature used in the inventive method is not particularly limited and may be selected in accordance with the boiling point of the solvent used and the half-life of the polymerization initiator used. However, since too high a polymerization temperature affects the stability of monomers and product polymer, the polymerization temperature is preferably in the range of 40 to 140° C., more preferably 50 to 120° C.

In the inventive method, polymerization is generally carried out under atmospheric pressure although the reaction pressure is not particularly limited.

In the inventive method, the solution to be added dropwise to the polymerization solution may be added dropwise in a continuous or discontinuous fashion. In the case of continuous addition, the rate of addition is not particularly limited. The rate of addition may be changed in the course of dropwise addition.

The time for which the solution is added dropwise to the polymerization solution is not particularly limited. However, if the dropwise addition time is too short, a polymer being formed at the initial stage of polymerization tends to have a biased polymer composition and an increased molecular weight, with a likelihood that a component which is substantially insoluble in resist solvent is produced. Thus, the dropwise addition time of the solution is preferably at least 2 hours, more preferably at least 3 hours. The addition time is generally up to 20 hours, especially up to 15 hours, although the upper limit is not particularly restrictive.

In the method of the invention, after the supply of the monomers and polymerization initiator to the polymerization solution is terminated, the solution within the reactor, with stirring, is kept at the polymerization temperature for a certain time, preferably 1 to 5 hours, more preferably 1 to 4 hours, until the polymerization reaction is completed.

The polymerization solution resulting from the above method is, without further treatment, ready for use as a base resin solution in a resist composition.

If necessary, the polymerization solution resulting from the above method may be diluted with a suitable solvent to a suitable solution viscosity, and added dropwise to a poor solvent or a mixture of a poor solvent and a good solvent whereupon the product polymer will precipitate out. By way of this precipitation step, the unreacted monomers and polymerization initiator left in the polymerization solution can be removed. Further if necessary, after the polymer precipitated is separated, it may be further purified by washing with a poor solvent or a mixture of a poor solvent and a good solvent.

The good solvent used herein includes those solvents exemplified above as the solvent used in the polymerization step. The poor solvent used for polymer precipitation is not particularly limited as long as the polymer is not soluble therein. Exemplary poor solvents include water, methanol, isopropanol, hexane and heptane.

To reduce the variation of purification level between to manufacturing lots, the steps of precipitating and washing the polymer are preferably carried out at a certain temperature. The temperature is generally 0° C. to 60° C. though not particularly limited.

The polymer as purified above may be used as a base resin in a resist composition after the residual solvent is removed by vacuum drying. The drying temperature is generally 30° C. to 80° C. though not particularly limited. The drying time is not particularly limited and may be selected as appropriate by determining the amount of residual solvent in the polymer.

The polymer as purified may also be prepared as a base resin solution for resist use by adding a resist solvent, dissolving the polymer therein, and distilling off the other solvents under reduced pressure. The temperature of the solution forming step may be selected based on the boiling point of the resist solvent, and is generally 30° C. to 80° C.

The method of preparing a polymer for use in resist compositions according to the invention is applicable, without particular limitation, whenever a monomer having a double bond capable of radical polymerization is polymerized, and advantageous particularly when a monomer having a group (i.e., acid-labile group) capable of reacting with an acid to yield a polar group which is soluble in alkaline developer and a monomer having a lactone structure are copolymerized. At this point, in addition to the monomer having an acid-labile group and the monomer having a lactone structure, another monomer may be copolymerized for tailoring the characteristics of the resist composition. For each of the monomer having an acid-labile group, the monomer having a lactone structure, and the other monomer, two or more species may be used.

Exemplary of the monomer having an acid-labile group are monomers having the general formula (1):

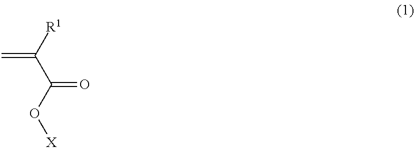

wherein R¹ is hydrogen, fluorine, methyl or trifluoromethyl, and X is an acid labile group (or acid-eliminatable group).

The acid labile groups represented by X may be selected from a variety of such groups. Examples of the acid labile group are groups of the following general formulae (L1) to (L4), tertiary alkyl groups of 4 to 20 carbon atoms, preferably 4 to 15 carbon atoms, trialkylsilyl groups in which each alkyl moiety has 1 to 6 carbon atoms, and oxoalkyl groups of 4 to 20 carbon atoms.

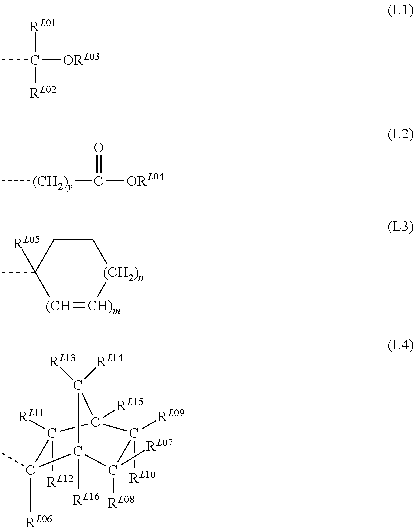

The broken line indicates a valence bond.

R^{L01} and L^{L02} are hydrogen or straight, branched or cyclic alkyl groups of 1 to 18 carbon atoms, preferably 1 to 10 carbon atoms. Exemplary alkyl groups include methyl, ethyl, propyl, isopropyl, n-butyl, sec-butyl, tert-butyl, cyclopentyl, cyclohexyl, 2-ethylhexyl, and n-octyl. R^{L03} is a monovalent hydrocarbon group of 1 to 18 carbon atoms, preferably 1 to 10 carbon atoms, which may contain a hetero atom such as oxygen, examples of which include unsubstituted straight, branched or cyclic alkyl groups and straight, branched or cyclic alkyl groups in which some hydrogen atoms are replaced by hydroxyl, alkoxy, oxo, amino, alkylamino or the like.

A pair of R^{L01} and R^{L02}, R^{L01} and R^{L03}, or R^{L02} and R^{L03} may bond together to form a ring with the carbon and oxygen atoms to which they are attached. Each of R^{L01}, R^{L02} and R^{L03} is a straight or branched alkylene group of 1 to 18 carbon atoms, preferably 1 to 10 carbon atoms when they form a ring.

R^{L04} is a tertiary alkyl group of 4 to 20 carbon atoms, preferably 4 to 15 carbon atoms, a trialkylsilyl group in which each alkyl moiety has 1 to 6 carbon atoms, an oxoalkyl group of 4 to 20 carbon atoms, or a group of formula (L1). Exemplary tertiary alkyl groups are tert-butyl, tert-amyl, 1,1-diethylpropyl, 2-cyclopentylpropan-2-yl, 2-cyclohexylpropan-2-yl, 2-(bicyclo[2.2.1]heptan-2-yl, 2-(adamantan-1-yl)propan-2-yl, 1-ethylcyclopentyl, 1-butylcyclopentyl, 1-ethylcyclohexyl, 1-butylcyclohexyl, 1-ethyl-2-cyclopentenyl, 1-ethyl-2-cyclohexenyl, 2-methyl-2-adamantyl, and 2-ethyl-2-adamantyl. Exemplary trialkylsilyl groups are trimethylsilyl, triethylsilyl, and dimethyl-tert-butylsilyl. Exemplary oxoalkyl groups are 3-oxocyclohexyl, 4-methyl-2-oxooxan-4-yl, and 5-methyl-2-oxooxolan-5-yl. The subscript y is an integer of 0 to 6.

R^{L05} is a straight, branched or cyclic C₁-C₁₀ alkyl group or a C₆-C₂₀ aryl group both of which may be optionally substituted. Examples of optionally substituted alkyl groups include straight, branched or cyclic alkyl groups such as methyl, ethyl, propyl, isopropyl, n-butyl, sec-butyl, tent-butyl, tert-amyl, n-pentyl, n-hexyl, cyclopentyl, cyclohexyl, norbornyl and adamantyl, and substituted forms of the foregoing in which some hydrogen atoms are replaced by hydroxyl, alkoxy, carboxy, alkoxycarbonyl, oxo, amino, alkylamino, cyano, alkylthio, sulfo or other groups and/or in which some —CH₁— moieties are replaced by oxygen atoms. Examples of optionally substituted aryl groups include phenyl, methylphenyl, naphthyl, anthryl, phenanthryl, and pyrenyl. In formula (L3), m is 0 or 1, n is 0, 1, 2 or 3, and 2 m+n is equal to 2 or 3.

R^{L06} is a straight, branched or cyclic C₁-C₈ alkyl group or a C₆-C₂₀ aryl group both of which may be optionally substituted. Examples of these groups are the same as exemplified for R^{L05}. R^{L07} to R^{L16} independently represent hydrogen or monovalent C₁-C₁₅ hydrocarbon groups. Exemplary hydrocarbon groups are straight, branched or cyclic alkyl groups such as methyl, ethyl, propyl, isopropyl, n-butyl, sec-butyl, tert-butyl, tert-amyl, n-pentyl, n-hexyl, n-octyl, n-nonyl, n-decyl, cyclopentyl, cyclohexyl, cyclopentylmethyl, cyclopentylethyl, cyclopentylbutyl, cyclohexylmethyl, cyclohexylethyl and cyclohexylbutyl, and substituted forms of the foregoing in which some hydrogen atoms are replaced by hydroxyl, alkoxy, carboxy, alkoxycarbonyl, oxo, amino, alkylamino, cyano, mercapto, alkylthio, sulfo or other groups. Alternatively, R^{L07} to R^{L16}, taken together, may form a ring (for example, a pair of R^{L07} and R^{L08}, R^{L07} and R^{L09}, R^{L08} and R^{L10}, R^{L09} and R^{L10}, R^{L11} and R^{L12}, R^{L13} and R^{L14}, or a similar pair form a ring). Each of R^{L07} to R^{L16} represents a divalent C₁-C₁₅ hydrocarbon group when they form a ring, examples of which are the ones exemplified above for the monovalent hydrocarbon groups, with one hydrogen atom being eliminated. Two of R^{L07} to R^{L16} which are attached to adjoining carbon atoms (for example, a pair of R^{L07} and R^{L09}, R^{L09} and R^{L15}, R^{L13} and R^{L15}, or a similar pair) may bond together directly to form a double bond.

Of the acid labile groups of formula (L1), the straight and branched ones are exemplified by the following groups.

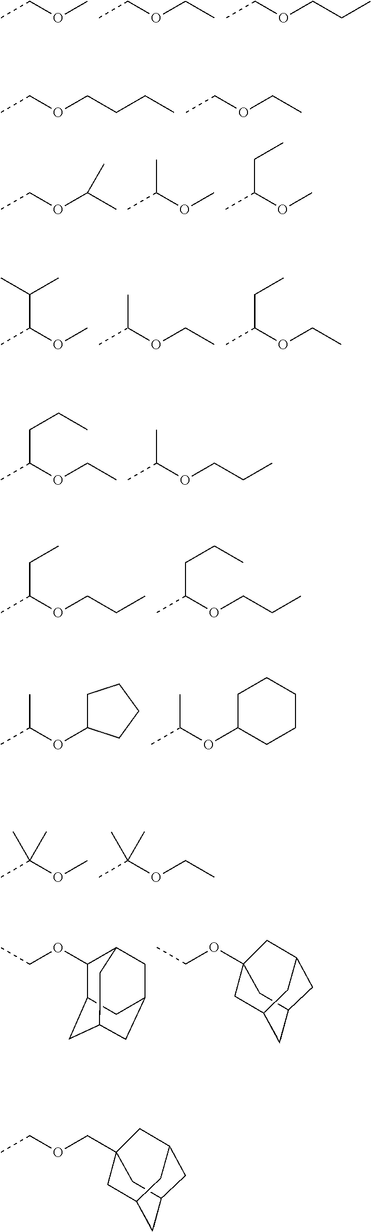

Of the acid labile groups of formula (L1), the cyclic ones are, for example, tetrahydrofuran-2-yl, 2-methyltetrahydrofuran-2-yl, tetrahydropyran-2-yl, and 2-methyltetrahydropyran-2-yl.

Examples of the acid labile groups of formula (L2) include tert-butoxycarbonyl, tert-butoxycarbonylmethyl, tert-amyloxycarbonyl, tert-amyloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl groups.

Examples of the acid labile groups of formula (L3) include 1-methylcyclopentyl, 1-ethylcyclopentyl, 1-n-propylcyclopentyl, 1-isopropylcyclopentyl, 1-n-butylcyclopentyl, 1-sec-butylcyclopentyl, 1-cyclohexylcyclopentyl, 1-(4-methoxy-n-butyl)cyclopentyl, 1-(norbornan-2-yl)cyclopentyl, 1-(7-oxanorbornan-2-yl)cyclopentyl, 1-methylcyclohexyl, 1-ethylcyclohexyl, 3-methyl-1-cyclopenten-3-yl, 3-ethyl-1-cyclopenten-3-yl, 3-methyl-1-cyclohexen-3-yl, and 3-ethyl-1-cyclohexen-3-yl groups.

The acid labile groups of formula (L4) are preferably groups of the following formulae (L4-1) to (L4-4).

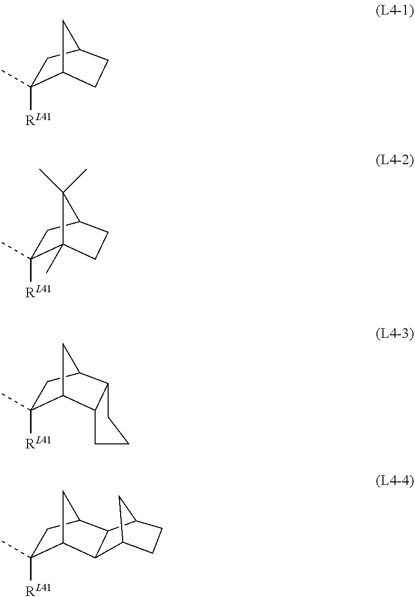

In formulae (L4-1) to (L4-4), the broken line indicates a bonding site and direction. R^{L41} is each independently selected from monovalent hydrocarbon groups, typically straight, branched or cyclic C₁-C₁₀ alkyl groups, for example, methyl, ethyl, propyl, isopropyl, n-butyl, sec-butyl, tert-butyl, tert-amyl, n-pentyl, n-hexyl, cyclopentyl, and cyclohexyl.

For formulas (L4-1) to (L4-4), there can exist enantiomers and diastereomers. Each of formulae (L4-1) to (L4-4) collectively represents all such stereoisomers. Such stereoisomers may be used alone or in admixture.

For example, the general formula (L4-3) represents one or a mixture of two selected from groups having the following general formulas (L4-3-1) and (L4-3-2).

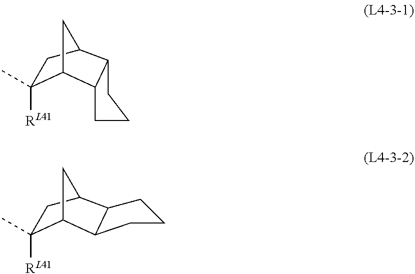

Similarly, the general formula (L4-4) represents one or a mixture of two or more selected from groups having the following general formulas (L4-4-1) to (L4-4-4).

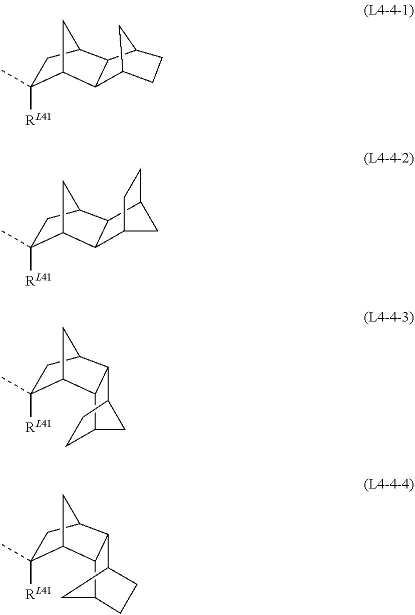

Each of formulas (L4-1) to (L4-4), (L4-3-1) and (L4-3-2), and (L4-4-1) to (L4-4-4) collectively represents an enantiomer thereof and a mixture of enantiomers.

It is noted that in the above formulas (L4-1) to (L4-4), (L4-3-1) and (L4-3-2), and (L4-4-1) to (L4-4-4), the bond direction is on the exo side relative to the bicyclo[2.2.1]heptane ring, which ensures high reactivity for acid catalyzed elimination reaction (see JP-A 2000-336121). In preparing these monomers having a tertiary exo-alkyl group of bicyclo[2.2.1]heptane skeleton as a substituent group, there may be contained monomers substituted with an endo-alkyl group as represented by the following formulas (L4-1-endo) to (L4-4-endo). For good reactivity, an exo proportion of at least 50 mol % is preferred, with an exo proportion of at least 80 mol % being more preferred.

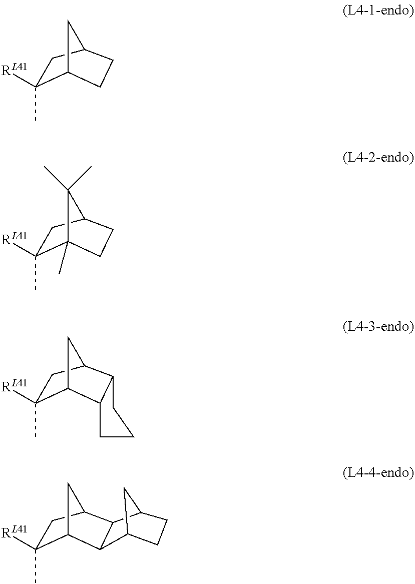

Illustrative examples of the acid labile group of formula (L4) are given below

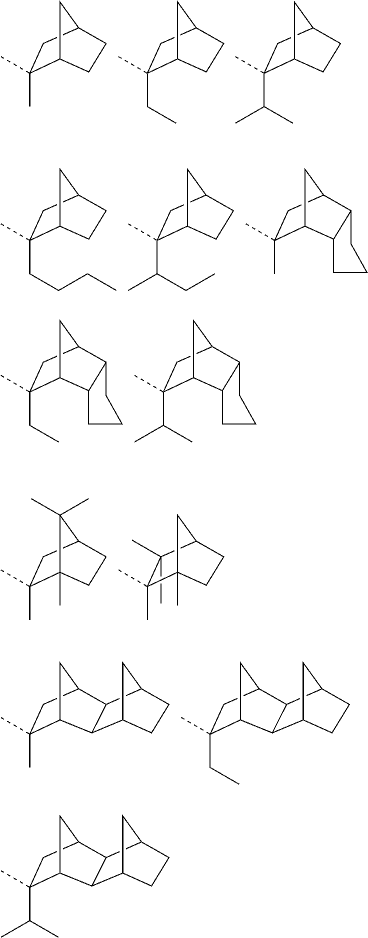

Examples of the tertiary C₄-C₂₀ alkyl, tri(C₁-C₆-alkyl)silyl and C₄-C₂₀ oxoalkyl groups included in the acid labile groups represented by X are as exemplified above for R^{L04}.

Illustrative examples of the monomer of formula (1) are given below, but not limited thereto.

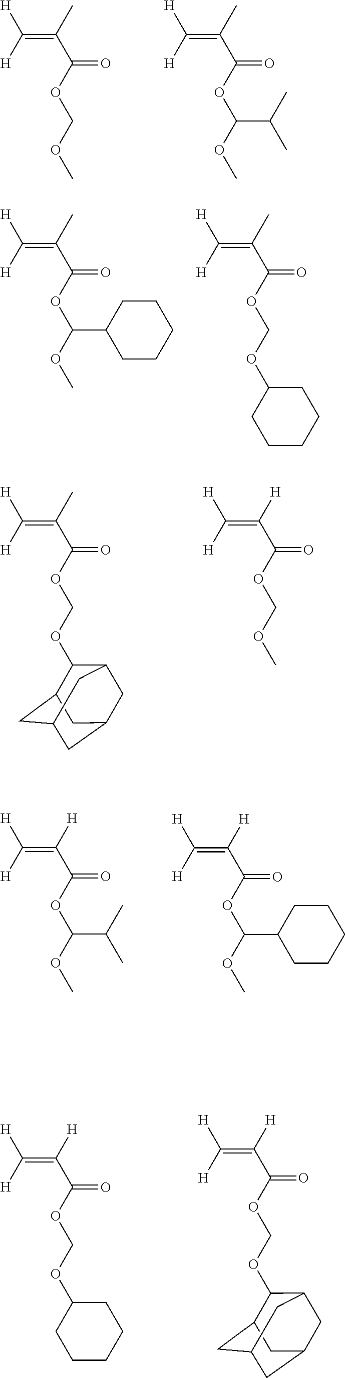

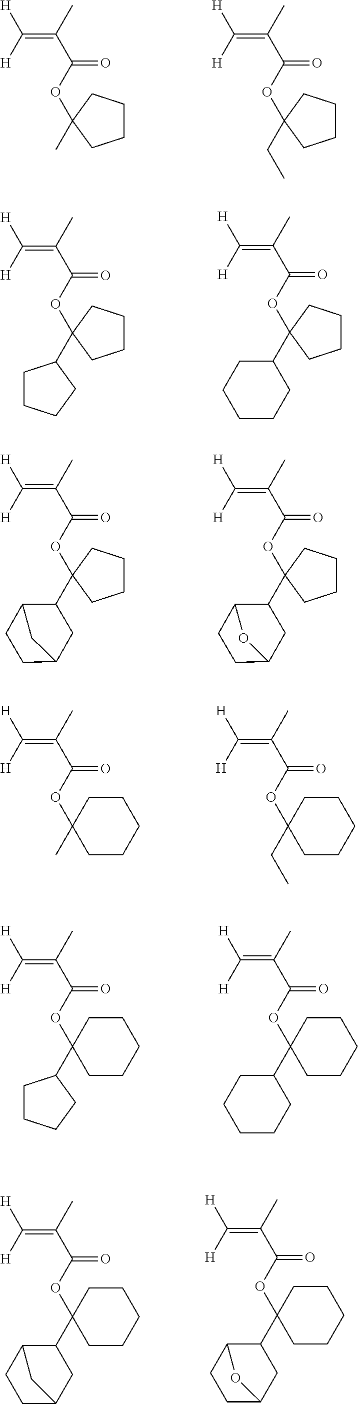

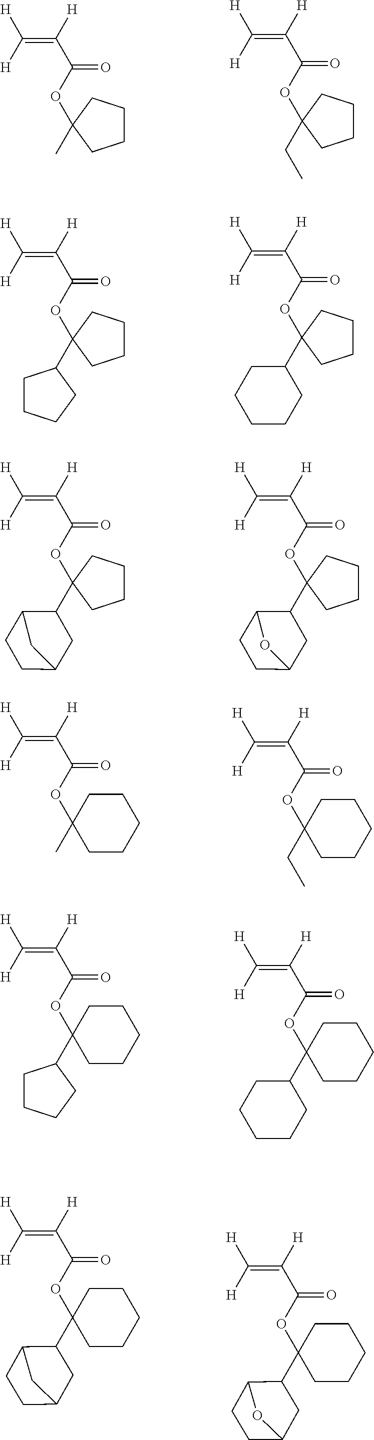

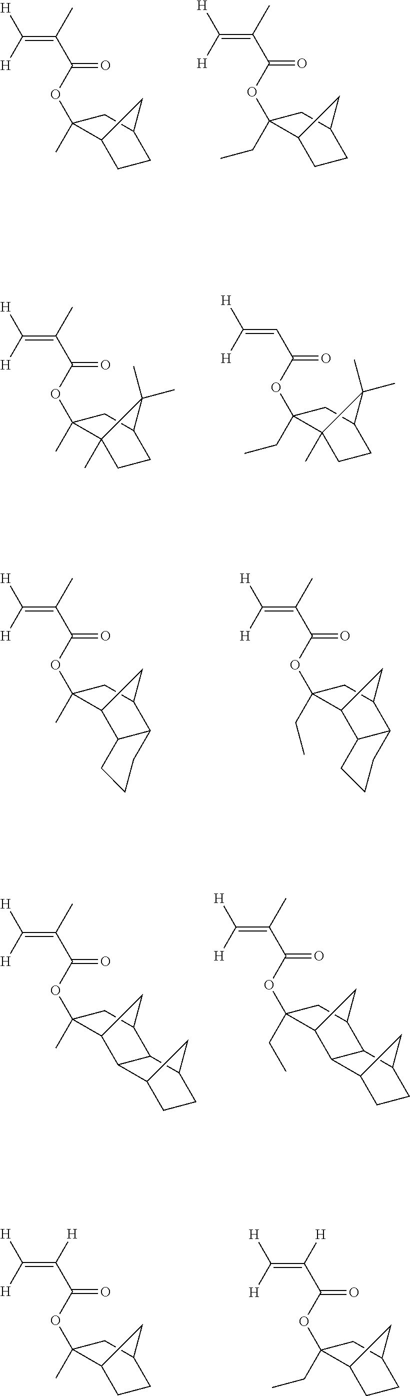

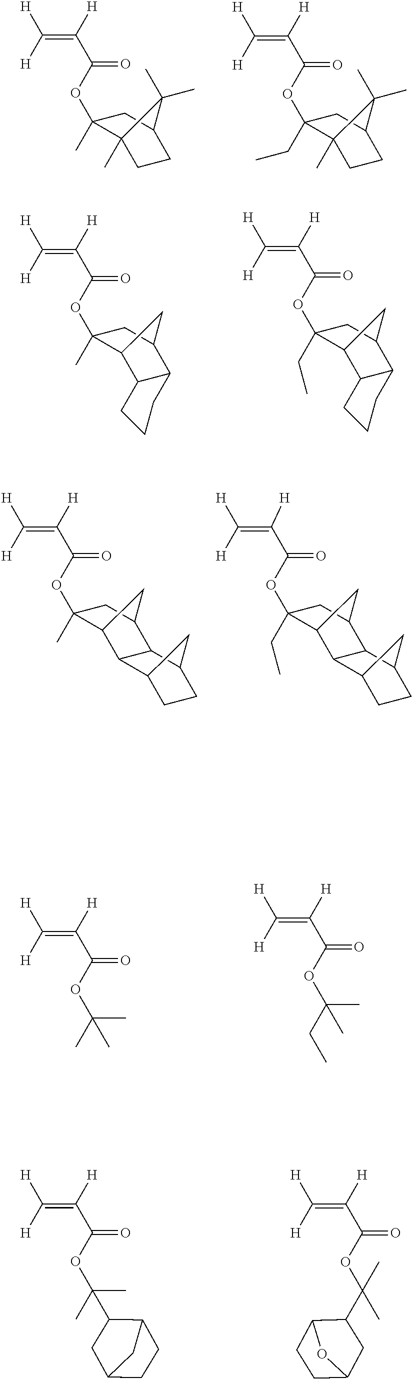

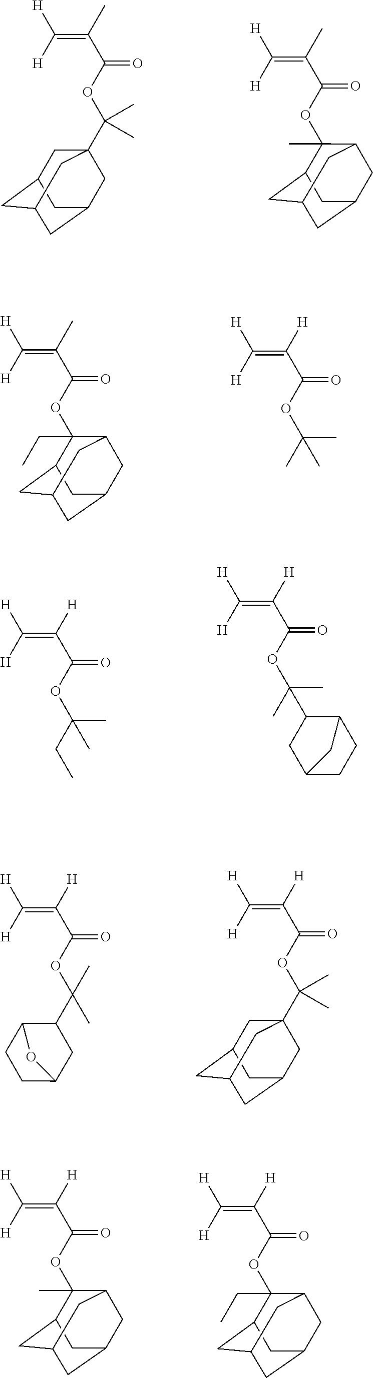

Exemplary of the monomer having a lactone structure are monomers having the general formula (2):

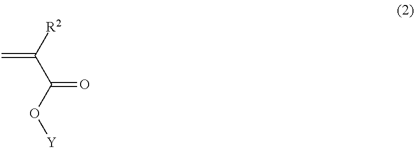

wherein R² is hydrogen, fluorine, methyl or trifluoromethyl, and Y is a substituent group having a lactone structure.

The substituent group having a lactone structure, represented by Y, may be selected from a variety of such groups, specifically groups of the general formulae (A1) to (A9) below.

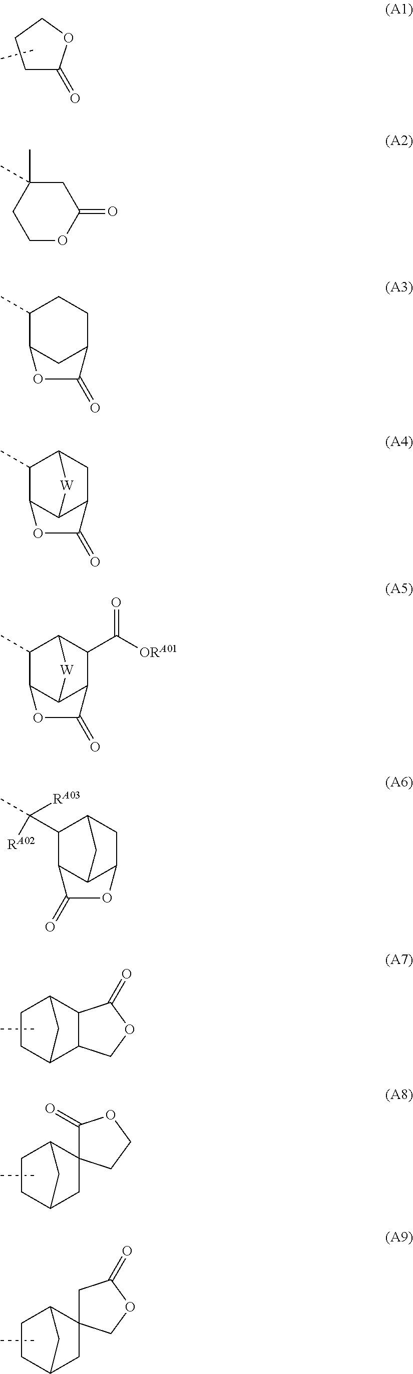

In the formulae, the broken line indicates a bonding site. W is CH₂, an oxygen atom or sulfur atom. R^{A01} is a monovalent hydrocarbon group, typically a straight, branched or cyclic C₁-C₁₀ alkyl group optionally having one or more fluorine atom. Examples include methyl, ethyl, propyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl groups, and such groups as shown below.

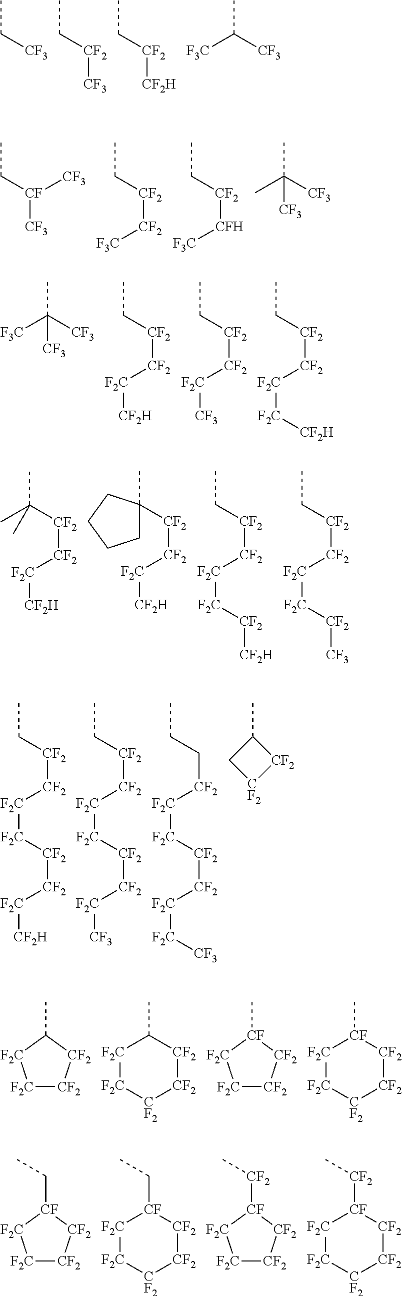

R^{A02} and R^{A03} are each independently hydrogen or a Monovalent hydrocarbon group, typically a straight, branched or cyclic C₁-C₁₀ alkyl group. Alternatively, R^{A02} and R^{A03} may bond together to form a ring with the carbon atom to which they are attached. Examples of straight, branched or cyclic, monovalent hydrocarbon groups of 1 to 10 carbon atoms represented by R^{A02} and R^{A03} include methyl, ethyl, propyl, isopropyl, n-butyl, sec-butyl, tert-butyl, n-pentyl, n-hexyl, cyclohexyl and n-decyl. When R^{A02} and R^{A03} bond together to form a ring, examples of the alkylene group resulting from such bonding include ethylene, propylene, trimethylene, and tetramethylene, and the ring may have 3 to 20 carbon atoms, especially 3 to 10 carbon atoms.

Illustrative examples of the monomer of formula (2) are given below, but not limited thereto.

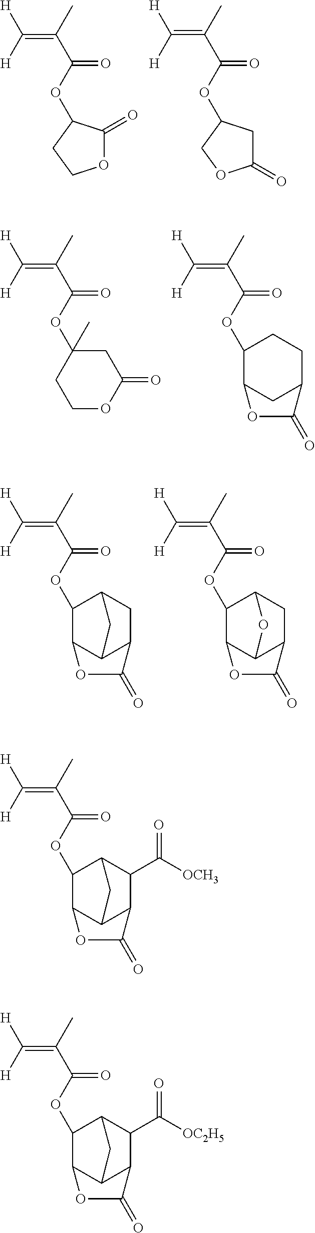

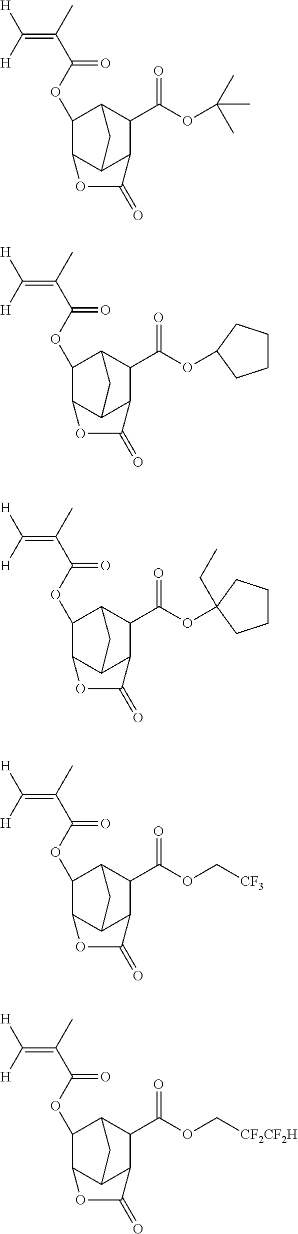

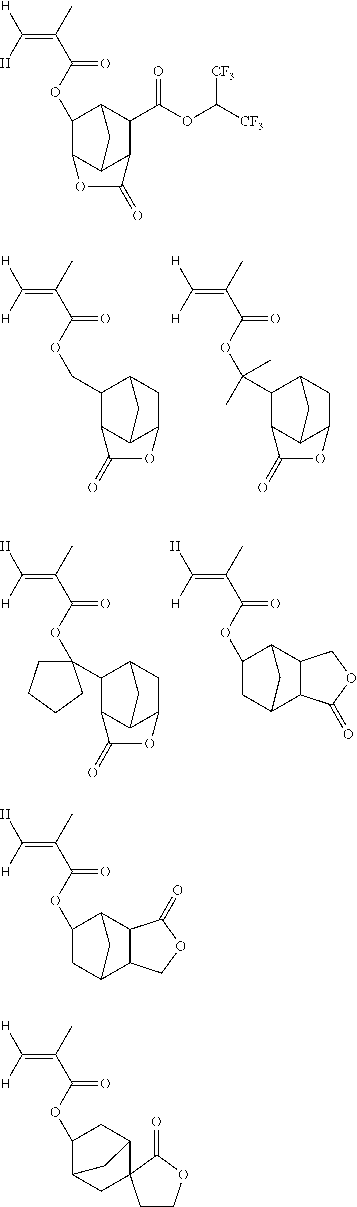

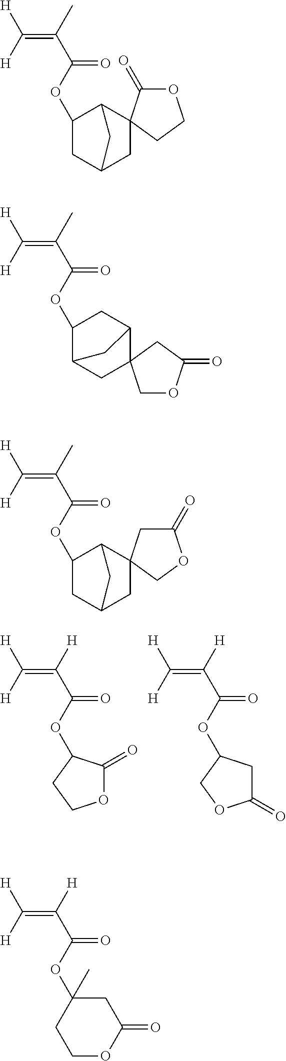

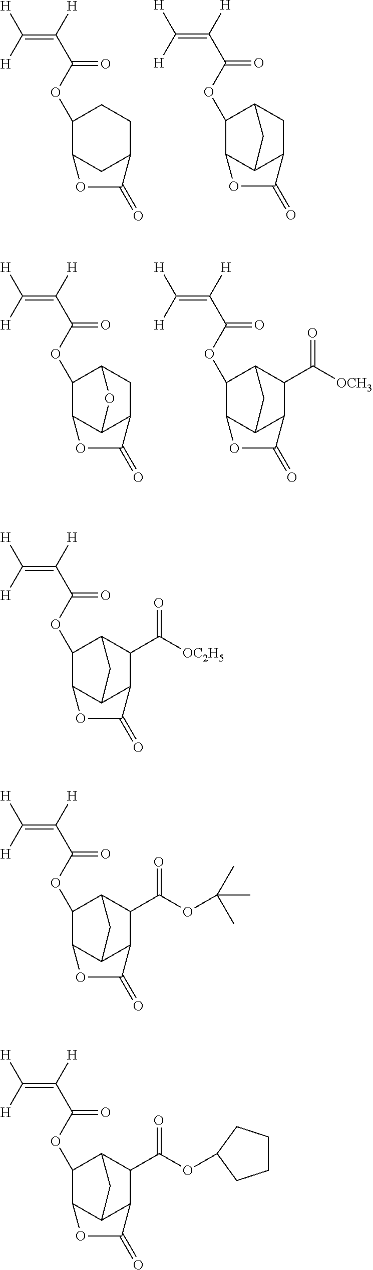

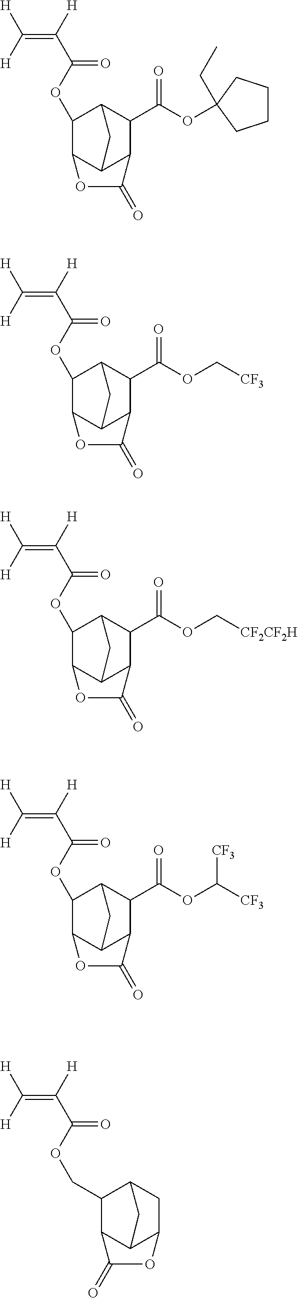

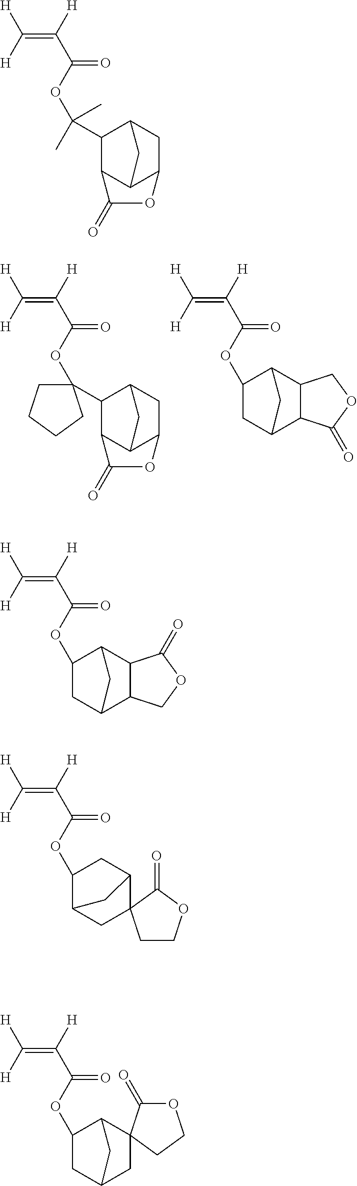

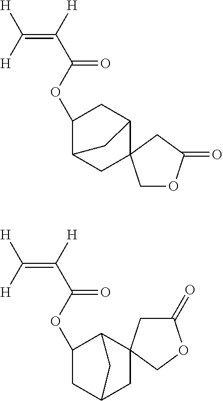

It is noted that of the monomers illustrated above, 2-oxo-tetrahydrofuran-3-yl methacrylate, 4,8-dioxatricyclo[4.2.1.0^{3,7}]nonan-5-on-2-yl methacrylate, and 9-methoxycarbonyl-4-oxatricyclo[4.2.1.0^{3,7}]nonan-5-on-2-yl methacrylate have a high polymerization reactivity by themselves. Accordingly, when one of the specified monomers and a monomer having an acid-eliminatable group are involved in polymerization, a polymer containing more recurring units derived from the specified monomer tends to form at the initial stage, with a likelihood of forming a component which is substantially insoluble in resist solvent.

The polymerization method of the invention is advantageously applicable to such a situation where polymerization tends to bring about a biased composition. Even when a polymer being formed at the initial stage of polymerization is likely to have a biased polymer composition, the molecular weight of the polymer can be fully reduced by optimizing the amount of chain transfer agent pre-charged in the reactor, whereby a base resin for resist use having a minimized content of a component which is substantially insoluble in resist solvent is produced.

It is also preferred in the method of the invention to copolymerize, in addition to the monomer having an acid-eliminatable group and the monomer having a lactone structure, one or more other monomers for improving the etch resistance of the polymer. For example, the other monomers have the general formula (3):

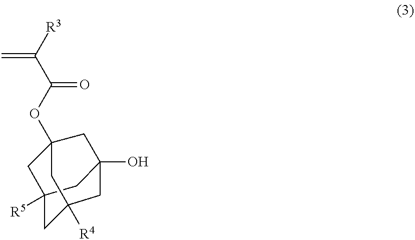

wherein R³ is hydrogen, fluorine, methyl or trifluoromethyl, and R⁴ and R⁵ are each independently hydrogen or hydroxyl.

Illustrative examples of the monomer of formula (3) are given below.

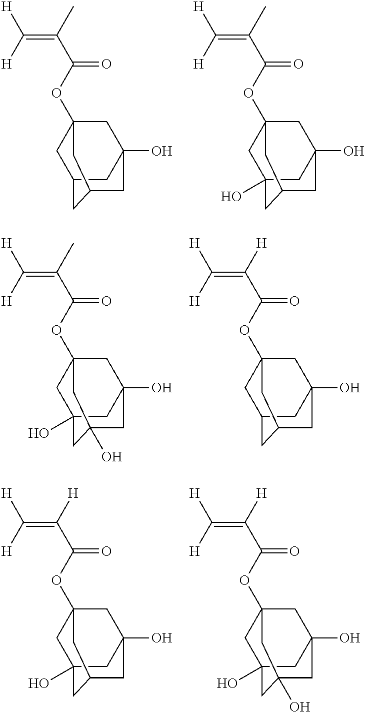

It is also preferred in the method of the invention to copolymerize one or more monomers selected from the following monomer group A for adjusting the alkaline developer affinity of the polymer.

### Monomer Group A

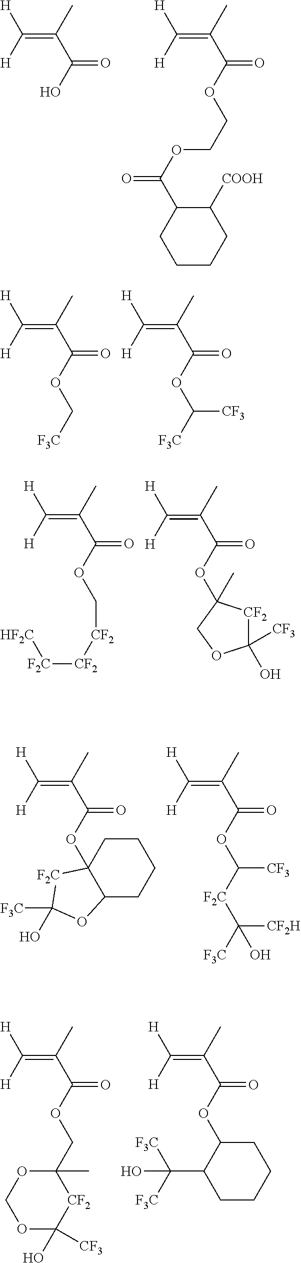

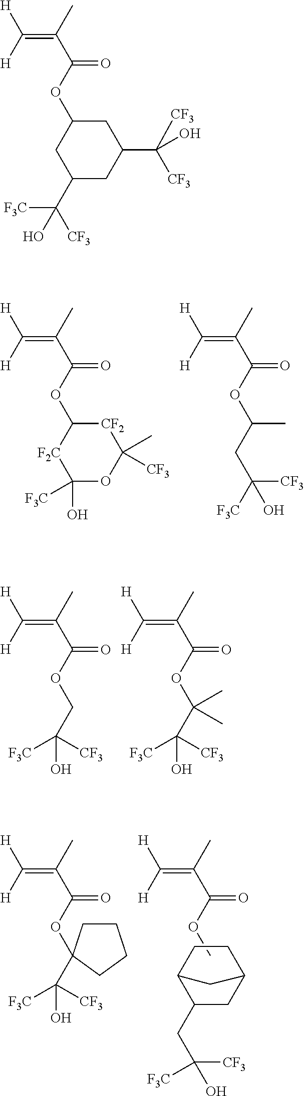

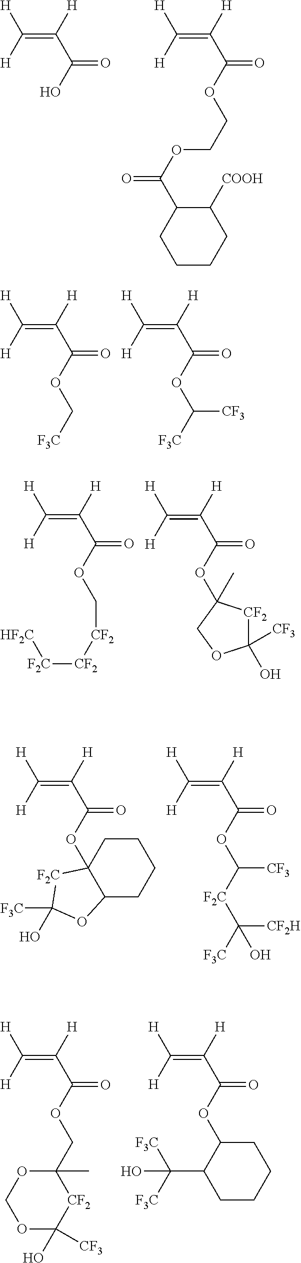

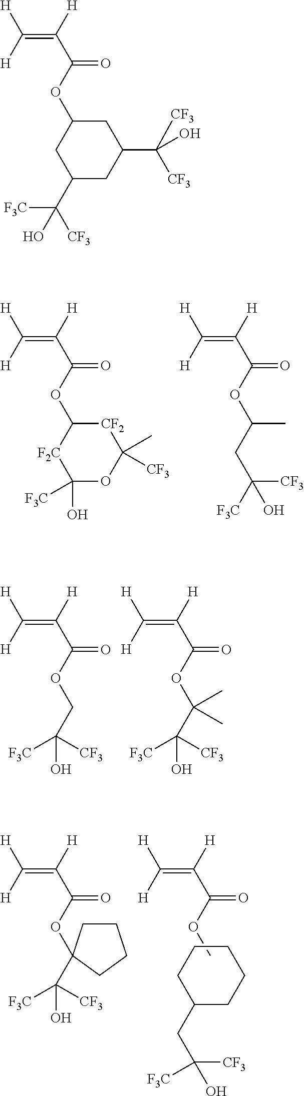

Still other monomers having a carbon-carbon double bond may also be copolymerized, for example, substituted acrylates such as methyl methacrylate, methyl chrotonate, dimethyl maleate and dimethyl itaconate; unsaturated carboxylic acids such as maleic acid, fumaric acid and itaconic acid; cycloolefins such as norbornene, norbornene derivatives, and tetracyclo[4.4.0.1^{2,5}.17^{7,10}]dodecene derivatives; unsaturated acid anhydrides such as maleic anhydride and itaconic anhydride; α,β-unsaturated lactones such as 5,5-dimethyl-3-methylene-2-oxotetrahydrofuran, and the like.

Preferably the polymer for use in resist compositions according to the invention has a weight average molecular weight (Mw) of 2,000 to 30,000, more preferably 3,000 to 20,000, as measured by gel permeation chromatography (GPC) versus polystyrene standards. With too low a Mw outside the range, a satisfactory pattern profile may not be available. With too high a Mw outside the range, a difference in dissolution rate before and after exposure may not be established, resulting in a decline of resolution.

In the polymer, appropriate proportions of respective recurring units derived from the monomers are in the following range (in mol %), but not limited thereto. The inventive polymer may contain:
(I) 10 to 70 mol %, more preferably 15 to 65 mol % of recurring units of one or more types derived from the monomer of formula (1),
(II) 5 to 70 mol %, more preferably 5 to 60 mol % of recurring units of one or more types derived from the monomer of formula (2), and optionally,
(III) 0 to 50 mol %, more preferably 1 to 50 mol %, even more preferably 5 to 45 mol % of recurring units of one or more types derived from the monomer of formula (3),
(IV) 0 to 60 mol %, more preferably 1 to 60 mol %, even more preferably 5 to 50 mol % of recurring units of one or more types derived from the monomer selected from monomer group A, and
(V) 0 to 30 mol %, more preferably 1 to 30 mol %, even more preferably 5 to 20 mol % of constituent units of one or more types derived from the still other monomer.

### Resist Composition

Since the polymer of the invention is useful as the base resin of a resist composition, the other aspect of the invention provides a resist composition comprising the polymer and specifically a chemically amplified positive resist composition comprising the polymer. Typically, the resist composition contains (A) the inventive polymer as a base resin, (B) an acid generator, (C) an organic solvent, and optionally (D) an organic nitrogen-containing compound and (E) a surfactant.

Acid Generator

As the acid generator (B), a photoacid generator (PAG) is typically used. It is any compound capable of generating an acid upon exposure to high-energy radiation. Suitable photoacid generators include sulfonium salts, iodonium salts, sulfonyldiazomethane, N-sulfonyloxyimide, and oxime-O-sulfonate acid generators. Exemplary acid generators are given below while they may be used alone or in admixture of two or more.

Sulfonium salts are salts of sulfonium cations with sulfonates, bis(substituted alkylsulfonyl)imides and tris(substituted alkylsulfonyl)methides. Exemplary sulfonium cations include triphenylsulfonium, (4-tert-butoxyphenyl)diphenylsulfonium, bis(4-tert-butoxyphenyl)phenylsulfonium, tris(4-tert-butoxyphenyl)sulfonium, (3-tert-butoxyphenyl)diphenylsulfonium, bis(3-tert-butoxyphenyl)phenylsulfonium, tris(3-tert-butoxyphenyl)sulfonium, (3,4-di-tert-butoxyphenyl)diphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, (4-tert-butoxycarbonylmethyloxyphenyl)diphenylsulfonium, tris(4-tert-butoxycarbonylmethyloxyphenyl)sulfonium, (4-tert-butoxyphenyl)bis(4-dimethylaminophenyl)sulfonium, tris(4-dimethylaminophenyl)sulfonium, 2-naphthyldiphenylsulfonium, dimethyl-2-naphthylsulfonium, 4-hydroxyphenyldimethylsulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, 2-oxo-2-phenylethylthiacyclopentanium, 4-n-butoxynaphthyl-1-thiacyclopentanium, and 2-n-butoxynaphthyl-1-thiacyclopentanium. Exemplary sulfonates include trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4′-toluenesulfonyloxy)benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropane-sulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Exemplary bis(substituted alkylsulfonyl)imides include bistrifluoromethylsulfonylimide, bispentafluoroethylsulfonylimide, bisheptafluoropropylsulfonylimide, and 1,3-propylenebissulfonylimide. A typical tris(substituted alkylsulfonyl)methide is tristrifluoromethylsulfonylmethide. Sulfonium salts based on combination of the foregoing examples are included.

Iodonium salts are salts of iodonium cations with sulfonates, bis(substituted alkylsulfonyl)imides and tris(substituted alkylsulfonyl)methides. Exemplary iodonium cations are aryliodonium cations including diphenyliodinium, bis(4-tert-butylphenyl)iodonium, 4-tert-butoxyphenylphenyliodonium, and 4-methoxyphenylphenyliodonium. Exemplary sulfonates include trifluoromethanesulfonate, pentafluoroethanesulfonate, nonafluorobutanesulfonate, dodecafluorohexanesulfonate, pent afluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4-toluenesulfonyloxy)benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropane-sulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropane-sulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Exemplary bis(substituted alkylsulfonyl)imides include bistrifluoromethylsulfonylimide, bispentafluoroethylsulfonylimide, bisheptafluoropropylsulfonylimide, and 1,3-propylenebissulfonylimide. A typical tris(substituted alkylsulfonyl)methide is tristrifluoromethylsulfonylmethide. Iodonium salts based on combination of the foregoing examples are included.

Exemplary sulfonyldiazomethane compounds include bissulfonyldiazomethane compounds and sulfonyl-carbonyldiazomethane compounds such as bis(ethylsulfonyl)diazomethane, bis(1-methylpropylsulfonyl)diazomethane, bis(2-methylpropylsulfonyl)diazomethane, bis(1,1-dimethylethylsulfonyl)diazomethane, bis(cyclohexylsulfonyl)diazomethane, bis(perfluoroisopropylsulfonyl)diazomethane, bis(phenylsulfonyl)diazomethane, bis(4-methylphenylsulfonyl)diazomethane, bis(2,4-dimethylphenylsulfonyl)diazomethane, bis(2-naphthylsulfonyl)diazomethane, bis(4-acetyloxyphenylsulfonyl)diazomethane, bis(4-methanesulfonyloxyphenylsulfonyl)diazomethane, bis(4-(4-toluenesulfonyloxy)phenylsulfonyl)diazomethane, bis(4-(n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, 4-methylphenylsulfonylbenzoyldiazomethane, tert-butylcarbonyl-4-methylphenylsulfonyldiazomethane, 2-naphthylsulfonylbenzoyldiazomethane, 4-methylphenylsulfonyl-2-naphthoyldiazomethane, methylsulfonylbenzoyldiazomethane, and tert-butoxycarbonyl-4-methylphenylsulfonyldiazomethane.

N-sulfonyloxyimide photoacid generators include combinations of imide skeletons with sulfonates. Exemplary imide skeletons are succinimide, naphthalene dicarboxylic acid imide, phthalimide, cyclohexyldicarboxylic acid imide, 5-norbornene-2,3-dicarboxylic acid imide, and 7-oxabicyclo[2.2.1]-5-heptene-2,3-dicarboxylic acid imide. Exemplary sulfonates include trifluoromethanesulfonate, pentafluoroethanesulfonate, nonafluorobutanesulfonate, dodecafluorohexanesulfonate, pent afluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropane-sulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropane-sulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate.

Benzoinsulfonate photoacid generators include benzoin tosylate, benzoin mesylate, and benzoin butanesulfonate.

Pyrogallol trisulfonate photoacid generators include pyrogallol, phloroglucinol, catechol, resorcinol, and hydroquinone, in which all the hydroxyl groups are substituted by trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate.

Nitrobenzyl sulfonate photoacid generators include 2,4-dinitrobenzyl sulfonates, 2-nitrobenzyl sulfonates, and 2,6-dinitrobenzyl sulfonates, with exemplary sulfonates including trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Also useful are analogous nitrobenzyl sulfonate compounds in which the nitro group on the benzyl side is substituted by a trifluoromethyl group.

Sulfone photoacid generators include bis(phenylsulfonyl)methane, bis(4-methylphenylsulfonyl)methane, bis(2-naphthylsulfonyl)methane, 2,2-bis(phenylsulfonyl)propane, 2,2-bis(4-methylphenylsulfonyl)propane, 2,2-bis(2-naphthylsulfonyl)propane, 2-methyl-2-(p-toluenesulfonyl)propiophenone, 2-cyclohexylcarbonyl-2-(p-toluenesulfonyl)propane, and 2,4-dimethyl-2-(p-toluenesulfonyl)pentan-3-one.

Photoacid generators in the form of glyoxime derivatives are described in Japanese Patent No. 2,906,999 and JP-A 9-301948 and include bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(methanesulfonyl)-α-dimethylglyoxime, bis-O-(trifluoromethanesulfonyl)-α-dimethylglyoxime, bis-O-(2,2,2-trifluoroethanesulfonyl)-α-dimethylglyoxime, bis-O-(10-camphorsulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-trifluoromethylbenzenesulfonyl)-α-dimethylglyoxime, bis-O-(xylenesulfonyl)-α-dimethylglyoxime, bis-O-(trifluoromethanesulfonyl)-nioxime, bis-O-(2,2,2-trifluoroethanesulfonyl)-nioxime, bis-O-(10-camphorsulfonyl)-nioxime, bis-O-(benzenesulfonyl)-nioxime, bis-O-(p-fluorobenzenesulfonyl)-nioxime, bis-O-(p-trifluoromethylbenzenesulfonyl)-nioxime, and bis-O-(xylenesulfonyl)-nioxime.

Also included are the oxime sulfonates described in U.S. Pat. No. 6,004,724, for example, (5-(4-toluenesulfonyl)oxyimino-5H-thiophen-2-ylidene)phenyl-acetonitrile, (5-(10-camphorsulfonyl)oxyimino-5H-thiophen-2-ylidene)phenyl acetonitrile, (5-n-octanesulfonyloxyimino-5H-thiophen-2-ylidene)phenyl-acetonitrile, (5-(4-toluenesulfonyl)oxyimino-5H-thiophen-2-ylidene)(2-methylphenyl)acetonitrile, (5-(10-camphorsulfonyl)oxyimino-5H-thiophen-2-ylidene)(2-methylphenyl)acetonitrile, (5-n-octanesulfonyloxyimino-5H-thiophen-2-ylidene)(2-methylphenyl)acetonitrile, etc. Also included are the oxime sulfonates described in U.S. Pat. No. 6,916,591, for example, (5-(4-(4-toluenesulfonyloxy)benzenesulfonyl)oxyimino-5H-thiophen-2-ylidene)phenylacetonitrile and (5-(2,5-bis(4-toluenesulfonyloxy)benzenesulfonyl)oxyimino-5H-thiophen-2-ylidene)phenylacetonitrile.

Also included are the oxime sulfonates described in U.S. Pat. No. 6,261,738 and JP-A 2000-314956, for example, 2,2,2-trifluoro-1-phenyl-ethanone oxime-O-methylsulfonate; 2,2,2-trifluoro-1-phenyl-ethanone oxime-O-(10-camphoryl-sulfonate); 2,2,2-trifluoro-1-phenyl-ethanone oxime-O-(4-methoxyphenylsulfonate); 2,2,2-trifluoro-1-phenyl-ethanone oxime-O-(1-naphthylsulfonate); 2,2,2-trifluoro-1-phenyl-ethanone oxime-O-(2-naphthylsulfonate); 2,2,2-trifluoro-1-phenyl-ethanone oxime-O-(2,4,6-trimethylphenylsulfonate); 2,2,2-trifluoro-1-(4-methylphenyl)-ethanone oxime-O-(10-camphorylsulfonate); 2,2,2-trifluoro-1-(4-methylphenyl)-ethanone oxime-O-(methylsulfonate); 2,2,2-trifluoro-1-(2-methylphenyl)-ethanone oxime-O-(10-camphorylsulfonate); 2,2,2-trifluoro-1-(2,4-dimethylphenyl)-ethanone oxime-O-(10-camphorylsulfonate); 2,2,2-trifluoro-1-(2,4-dimethylphenyl)-ethanone oxime-O-(1-naphthylsulfonate); 2,2,2-trifluoro-1-(2,4-dimethylphenyl)-ethanone oxime-O-(2-naphthylsulfonate); 2,2,2-trifluoro-1-(2,4,6-trimethylphenyl)-ethanone oxime-O-(10-camphorylsulfonate); 2,2,2-trifluoro-1-(2,4,6-trimethylphenyl)-ethanone oxime-O-(1-naphthylsulfonate); 2,2,2-trifluoro-1-(2,4,6-trimethylphenyl)-ethanone oxime-O-(2-naphthylsulfonate); 2,2,2-trifluoro-1-(4-methoxyphenyl)-ethanone oxime-O-methylsulfonate; 2,2,2-trifluoro-1-(4-methylthiophenyl)-ethanone oxime-O-methylsulfonate; 2,2,2-trifluoro-1-(3,4-dimethoxyphenyl)-ethanone oxime-O-methylsulfonate; 2,2,3,3,4,4,4-heptafluoro-1-phenyl-butanone oxime-O-(10-camphorylsulfonate); 2,2,2-trifluoro-1-(phenyl)-ethanone oxime-O-methylsulfonate; 2,2,2-trifluoro-1-(phenyl)-ethanone oxime-O-10-camphorylsulfonate; 2,2,2-trifluoro-1-(phenyl)-ethanone oxime-O-(4-methoxyphenyl)sulfonate; 2,2,2-trifluoro-1-(phenyl)-ethanone oxime-O-(1-naphthyl)-sulfonate; 2,2,2-trifluoro-1-(phenyl)-ethanone oxime-O-(2-naphthyl)sulfonate; 2,2,2-trlfluoro-1-(phenyl)-ethanone oxime-O-(2,4,6-trimethylphenyl)sulfonate; 2,2,2-trifluoro-1-(4-methylphenyl)-ethanone oxime-O-(10-camphoryl)sulfonate; 2,2,2-trifluoro-1-(4-methylphenyl)-ethanone oxime-O-methyl-sulfonate; 2,2,2-trifluoro-1-(2-methylphenyl)-ethanone oxime-O-(10-camphoryl)sulfonate; 2,2,2-trifluoro-1-(2,4-dimethyl-phenyl)-ethanone oxime-O-(1-naphthyl)sulfonate; 2,2,2-trifluoro-1-(2,4-dimethylphenyl)-ethanone oxime-O-(2-naphthyl)sulfonate; 2,2,2-trifluoro-1-(2,4,6-trimethyl-phenyl)-ethanone oxime-O-(10-camphoryl)sulfonate; 2,2,2-trifluoro-1-(2,4,6-trimethylphenyl)-ethanone oxime-O-(1-naphthyl)sulfonate; 2,2,2-trifluoro-1-(2,4,6-trimethyl-phenyl)-ethanone oxime-O-(2-naphthyl)sulfonate; 2,2,2-trifluoro-1-(4-methoxyphenyl)-ethanone oxime-O-methylsulfonate; 2,2,2-trifluoro-1-(4-thiomethylphenyl)-ethanone oxime-O-methylsulfonate; 2,2,2-trifluoro-1-(3,4-dimethoxyphenyl)-ethanone oxime-O-methylsulfonate; 2,2,2-trifluoro-1-(4-methoxyphenyl)-ethanone oxime-O-(4-methylphenyl)sulfonate; 2,2,2-trifluoro-1-(4-methoxyphenyl)-ethanone oxime-O-(4-methoxyphenyl)sulfonate; 2,2,2-trifluoro-1-(4-methoxyphenyl)-ethanone oxime-O-(4-dodecylphenyl)-sulfonate; 2,2,2-trifluoro-1-(4-methoxyphenyl)-ethanone oxime-O-octylsulfonate; 2,2,2-trifluoro-1-(4-thiomethyl-phenyl)-ethanone oxime-O-(4-methoxyphenyl)sulfonate; 2,2,2-trifluoro-1-(4-thiomethylphenyl)-ethanone oxime-O-(4-dodecylphenyl)sulfonate; 2,2,2-trifluoro-1-(4-thiomethyl-phenyl)-ethanone oxime-O-octylsulfonate; 2,2,2-trifluoro-1-(4-thiomethylphenyl)-ethanone oxime-O-(2-naphthyl)sulfonate; 2,2,2-trifluoro-1-(2-methylphenyl)-ethanone oxime-O-methylsulfonate; 2,2,2-trifluoro-1-(4-methylphenyl)ethanone oxime-O-phenylsulfonate; 2,2,2-trifluoro-1-(4-chlorophenyl)-ethanone oxime-O-phenylsulfonate; 2,2,3,3,4,4,4-heptafluoro-1-(phenyl)-butanone oxime-O-(10-camphoryl)sulfonate; 2,2,2-trifluoro-1-naphthyl-ethanone oxime-O-methylsulfonate; 2,2,2-trifluoro-2-naphthyl-ethanone oxime-O-methylsulfonate; 2,2,2-trifluoro-1-[4-benzylphenyl]-ethanone oxime-O-methylsulfonate; 2,2,2-trifluoro-1-[4-(phenyl-1,4-dioxa-but-1-yl)phenyl]-ethanone oxime-O-methylsulfonate; 2,2,2-trifluoro-1-naphthyl-ethanone oxime-O-propylsulfonate; 2,2,2-trifluoro-2-naphthyl-ethanone oxime-O-propylsulfonate; 2,2,2-trifluoro-1-[4-benzylphenyl]-ethanone oxime-O-propyl-sulfonate; 2,2,2-trifluoro-1-[4-methylsulfonylphenyl]-ethanone oxime-O-propylsulfonate; 1,3-bis[1-(4-phenoxyphenyl)-2,2,2-trifluoroethanone oxime-O-sulfonyl]phenyl; 2,2,2-trifluoro-1-[4-methylsulfonyl-oxyphenyl]-ethanone oxime-O-propylsulfonate; 2,2,2-trifluoro-1-[4-methylcarbonyloxyphenyl]-ethanone oxime-O-propylsulfonate; 2,2,2-trifluoro-1-[6H,7H-5,8-dioxonaphth-2-yl]-ethanone oxime-O-propylsulfonate; 2,2,2-trifluoro-1-[4-methoxycarbonylmethoxyphenyl]-ethanone oxime-O-propylsulfonate; 2,2,2-trifluoro-1-[4-(methoxycarbonyl)-(4-amino-1-oxa-pent-1-yl)-phenyl]-ethanone oxime-O-propylsulfonate; 2,2,2-trifluoro-1-[3,5-dimethyl-4-ethoxyphenyl]-ethanone oxime-O-propylsulfonate; 2,2,2-trifluoro-1-[4-benzyloxyphenyl]-ethanone oxime-O-propylsulfonate; 2,2,2-trifluoro-1-[2-thiophenyl]-ethanone oxime-O-propylsulfonate; 2,2,2-trifluoro-1-[1-dioxa-thiophen-2-yl)]-ethanone oxime-O-propylsulfonate; 2,2,2-trifluoro-1-(4-(3-(4-(2,2,2-trifluoro-1-(trifluoromethanesulfonyloxy-imino)-ethyl)-phenoxy)-propoxy)-phenyl)ethanone oxime(trifluoromethanesulfonate); 2,2,2-trifluoro-1-(4-(3-(4-(2,2,2-trifluoro-1-(1-propanesulfonyloxylmino)-ethyl)-phenoxy)-propoxy)-phenyl)ethanone oxime(1-propanesulfonate); and 2,2,2-trifluoro-1-(4-(3-(4-(2,2,2-trifluoro-1-(1-butanesulfonyloxyimino)-ethyl)-phenoxy)-propoxy)-phenyl)ethanone oxime(1-butanesulfonate). Also included are the oxime sulfonates described in U.S. Pat. No. 6,916,591, for example, 2,2,2-trifluoro-1-(4-(3-(4-(2,2,2-trifluoro-1-(4-(4-methyl-phenylsulfonyloxy)phenylsulfonyloxyimino)-ethyl)-phenoxy)-propoxy)-phenyl)ethanone oxime(4-(4-methylphenylsulfonyloxy)-phenylsulfonate) and 2,2,2-trifluoro-1-(4-(3-(4-(2,2,2-trifluoro-1-(2,5-bis(4-methylphenylsulfonyloxy)benzenesulfonyloxy)-phenylsulfonyloxyimino)-ethyl)-phenoxy)-propoxy)-phenyl)ethanone oxime(2,5-bis(4-methylphenylsulfonyloxy)-benzenesulfonyloxy)phenylsulfonate).

Also included are the oxime sulfonates described in JP-A 9-95479 and JP-A 9-230588 and the references cited therein, for example, α-(p-toluenesulfonyloxyimino)-phenylacetonitrile, α-(p-chlorobenzenesulfonyloxyimino)-phenylacetonitrile, α-(4-nitrobenzenesulfonyloxyimino)-phenylacetonitrile, α-(4-nitro-2-trifluoromethylbenzenesulfonyloxyimino)-phenylacetonitrile, α-(benzenesulfonyloxylmino)-4-chlorophenylacetonitrile, α-(benzenesulfonyloxyimino)-2,4-dichlorophenylacetonitrile, α-(benzenesulfonyloxyimino)-2,6-dichlorophenylacetonitrile, α-(benzenesulfonyloxylmino)-4-methoxyphenylacetonitrile, α-(2-chlorobenzenesulfonyloxyimino)-4-methoxyphenyl-acetonitrile, α-(benzenesulfonyloxylmino)-2-thienylacetonitrile, α-(4-dodecylbenzenesulfonyloxylmino)-phenylacetonitrile, α-[(4-toluenesulfonyloxyimino)-4-methoxyphenyl]acetonitrile, α-[(dodecylbenzenesulfonyloxyimino)-4-methoxyphenyl]-acetonitrile, α-(tosyloxyimino)-3-thienylacetonitrile, α-(methylsulfonyloxyimino)-1-cyclopentenylacetonitrile, α-(ethylsulfonyloxyimino)-1-cyclopentenylacetonitrile, α-(isopropylsulfonyloxyimino)-1-cyclopentenylacetonitrile, α-(n-butylsulfonyloxyimino)-1-cyclopentenylacetonitrile, α-(ethylsulfonyloxyimino)-1-cyclohexenylacetonitrile, α-(isopropylsulfonyloxyimino)-1-cyclohexenylacetonitrile, and α-(n-butylsulfonyloxyimino)-1-cyclohexenylacetonitrile.

Also included are oxime sulfonates having the formula:

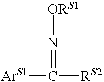

wherein R^{s1} is a substituted or unsubstituted haloalkylsulfonyl or halobenzenesulfonyl group of 1 to 10 carbon atoms, R^{s2} is a haloalkyl group of 1 to 11 carbon atoms, and Ar^{s1} is substituted or unsubstituted aromatic or hetero-aromatic group, as described in WO 2004/074242. Examples include 2-[2,2,3,3,4,4,5,5-octafluoro-1-(nonafluorobutylsulfonyloxyimino)-pentyl]-fluorene, 2-[2,2,3,3,4,4-pentafluoro-1-(nonafluorobutylsulfonyloxy-imino)-butyl]-fluorene, 2-[2,2,3,3,4,4,5,5,6,6-decafluoro-1-(nonafluorobutylsulfonyl-oxyimino)-hexyl]-fluorene, 2-[2,2,3,3,4,4,5,5-octafluoro-1-(nonafluorobutylsulfonyloxy-imino)-pentyl]-4-biphenyl, 2-[2,2,3,3,4,4-pentafluoro-1-(nonafluorobutylsulfonyloxy-imino)-butyl]-4-biphenyl, and 2-[2,2,3,3,4,4,5,5,6,6-decafluoro-1-(nonafluorobutylsulfonyl-oxyimino)-hexyl]-4-biphenyl.

Suitable bisoxime sulfonates include those described in JP-A 9-208554, for example, bis(α-(4-toluenesulfonyloxy)imino)-p-phenylenediacetonitrile, bis(α-(benzenesulfonyloxy)imino)-p-phenylenediacetonitrile, bis(α-(methanesulfonyloxy)imino)-p-phenylenediacetonitrile, bis(α-(butanesulfonyloxy)imino)-p-phenylenediacetonitrile, bis(α-(10-camphorsulfonyloxy)imino)-p-phenylenediacetonitrile, bis(α-(4-toluenesulfonyloxy)imino)-p-phenylenediacetonitrile, bis(α-(trifluoromethanesulfonyloxy)imino)-p-phenylene-diacetonitrile, bis(α-(4-methoxybenzenesulfonyloxy)imino)-p-phenylene-diacetonitrile, bis(α-(4-toluenesulfonyloxy)imino)-m-phenylenediacetonitrile, bis(α-(benzenesulfonyloxy)imino)-m-phenylenediacetonitrile, bis(α-(methanesulfonyloxy)imino)-m-phenylenediacetonitrile, bis(α-(butanesulfonyloxy)imino)-m-phenylenediacetonitrile, bis(α-(10-camphorsulfonyloxy)imino)-m-phenylenediacetonitrile, bis(α-(4-toluenesulfonyloxy)imino)-m-phenylenediacetonitrile, bis(α-(trifluoromethanesulfonyloxy)imino)-m-phenylene-diacetonitrile, bis(α-(4-methoxybenzenesulfonyloxy)imino)-m-phenylene-diacetonitrile, etc.

Of these, preferred photoacid generators are sulfonium salts, bissulfonyldiazomethanes, N-sulfonyloxyimides, oxime-O-sulfonates and glyoxime derivatives. More preferred photoacid generators are sulfonium salts, bissulfonyldiazomethanes, N-sulfonyloxyimides, and oxime-O-sulfonates. Typical examples include
triphenylsulfonium p-toluenesulfonate,
triphenylsulfonium camphorsulfonate,
triphenylsulfonium pentafluorobenzenesulfonate,
triphenylsulfonium nonafluorobutanesulfonate,
triphenylsulfonium 4-(4′-toluenesulfonyloxy)benzenesulfonate,
triphenylsulfonium 2,4,6-triisopropylbenzenesulfonate,
4-tert-butoxyphenyldiphenylsulfonium p-toluenesulfonate,
4-tert-butoxyphenyldiphenylsulfonium camphorsulfonate,
4-tert-butoxyphenyldiphenylsulfonium 4-(4′-toluene-sulfonyloxy)benzenesulfonate,
tris(4-methylphenyl)sulfonium camphorsulfonate,
tris(4-tert-butylphenyl)sulfonium camphorsulfonate,
4-tert-butylphenyldiphenylsulfonium camphorsulfonate,
4-tert-butylphenyldiphenylsulfonium nonafluoro-1-butanesulfonate,
4-tert-butylphenyldiphenylsulfonium pentafluoroethyl-perfluorocyclohexanesulfonate,
4-tert-butylphenyldiphenylsulfonium perfluoro-1-octanesulfonate,
triphenylsulfonium 1,1-difluoro-2-naphthyl-ethanesulfonate, triphenylsulfonium 1,1,2,2-tetrafluoro-2-(norbornan-2-yl)-ethanesulfonate,
bis(tert-butylsulfonyl)diazomethane,
bis(cyclohexylsulfonyl)diazomethane,
bis(2,4-dimethylphenylsulfonyl)diazomethane,
bis(4-(n-hexyloxy)phenylsulfonyl)diazomethane,
bis(2-methyl-4-(n-hexyloxy)phenylsulfonyl)diazomethane,
bis(2,5-dimethyl-4-(n-hexyloxy)phenylsulfonyl)diazomethane,
bis(3,5-dimethyl-4-(n-hexyloxy)phenylsulfonyl)diazomethane,
bis(2-methyl-5-isopropyl-4-(n-hexyloxy)phenylsulfonyl)-diazomethane,
bis(4-tert-butylphenylsulfonyl)diazomethane,
N-camphorsulfonyloxy-5-norbornene-2,3-dicarboxylic acid imide,
N-p-toluenesulfonyloxy-5-norbornene-2,3-dicarboxylic acid imide,
2-[2,2,3,3,4,4,5,5-octafluoro-1-(nonafluorobutylsulfonyloxy-imino)-pentyl]-fluorene,
2-[2,2,3,3,4,4-pentafluoro-1-(nonafluorobutylsulfonyloxy-imino)-butyl]-fluorene, and
2-[2,2,3,3,4,4,5,5,6,6-decafluoro-1-(nonafluorobutylsulfonyl-oxyimino)-hexyl]-fluorene.

In the chemically amplified resist composition, an appropriate amount of the photoacid generator is, but not limited to, 0.1 to 20 parts, and especially 0.1 to 10 parts by weight per 100 parts by weight of the base resin. Too high a proportion of the photoacid generator may give rise to problems of degraded resolution and foreign matter upon development and resist film peeling. The photoacid generators may be used alone or in admixture of two or more. The transmittance of the resist film can be controlled by using a photoacid generator having a low transmittance at the exposure wavelength and adjusting the amount of the photoacid generator added.

In the resist composition, there may be added a compound which is decomposed with an acid to generate an acid, that is, acid-amplifier compound. For these compounds, reference should be made to J. Photopolym. Sci. and Tech., 8, 43-44, 45-46 (1995), and ibid., 9, 29-30 (1996).

Examples of the acid-amplifier compound include tert-butyl-2-methyl-2-tosyloxymethyl acetoacetate and 2-phenyl-2-(2-tosyloxyethyl)-1,3-dioxolane, but are not limited thereto. Of well-known photoacid generators, many of those compounds having poor stability, especially poor thermal stability exhibit an acid amplifier-like behavior.

In the resist composition, an appropriate amount of the acid-amplifier compound is up to 2 parts, and especially up to 1 part by weight per 100 parts by weight of the base resin. Excessive amounts of the acid-amplifier compound make diffusion control difficult, leading to degradation of resolution and pattern profile.

Organic Solvent

The organic solvent (C) used herein may be any organic solvent in which the base resin, acid generator, and other components are soluble. Illustrative, non-limiting, examples of the organic solvent include ketones such as cyclohexanone and methyl n-amyl ketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; esters such as propylene glycol monomethyl ether acetate (PGMEA), propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate; and lactones such as γ-butyrolactone. These solvents may be used alone or in combinations of two or more thereof. Of the above organic solvents, it is recommended to use diethylene glycol dimethyl ether, 1-ethoxy-2-propanol, propylene glycol monomethyl ether acetate, and mixtures thereof because the acid generator is most soluble therein.

An appropriate amount of the organic solvent used is about 200 to 3,000 parts, especially about 400 to 2,500 parts by weight per 100 parts by weight of the base resin in the resist composition.

Nitrogen-Containing Compound

In the resist composition, an organic nitrogen-containing compound or compounds (D) may be compounded. The organic nitrogen-containing compound used herein is preferably a compound capable of suppressing the rate of diffusion when the acid generated by the acid generator diffuses within the resist film. The inclusion of this type of organic nitrogen-containing compound holds down the rate of acid diffusion within the resist film, resulting in better resolution. In addition, it suppresses changes in sensitivity following exposure and reduces substrate and environment dependence, as well as improving the exposure latitude and the pattern profile.

Examples of organic nitrogen-containing compounds include primary, secondary, and tertiary aliphatic amines, mixed amines, aromatic amines, heterocyclic amines, nitrogen-containing compounds having carboxyl group, nitrogen-containing compounds having sulfonyl group, nitrogen-containing compounds having hydroxyl group, nitrogen-containing compounds having hydroxyphenyl group, alcoholic nitrogen-containing compounds, amide derivatives, imide derivatives, and carbamate derivatives.

Examples of suitable primary aliphatic amines include ammonia, methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. Examples of suitable secondary aliphatic amines include dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. Examples of suitable tertiary aliphatic amines include trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of suitable mixed amines include dimethylethylamine, methylethylpropylamine, benzylamine, phenethylamine, and benzyldimethylamine. Examples of suitable aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 4-pyrrolidinopyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives.

Examples of suitable nitrogen-containing compounds having carboxyl group include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable nitrogen-containing compounds having sulfonyl group include 3-pyridinesulfonic acid and pyridinium p-toluenesulfonate. Examples of suitable nitrogen-containing compounds having hydroxyl group, nitrogen-containing compounds having hydroxyphenyl group, and alcoholic nitrogen-containing compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. Examples of suitable amide derivatives include formamide, N-methylformamide, N,N-dimethylformamide, acetamide, N-methylacetamide, N,N-dimethylacetamide, propionamide, benzamide, and 1-cyclohexylpyrrolidone. Suitable imide derivatives include phthalimide, succinimide, and maleimide. Suitable carbamate derivatives include N-t-butoxycarbonyl-N,N-dicyclohexylamine, N-t-butoxycarbonylbenzimidazole and oxazolidinone.

In addition, organic nitrogen-containing compounds of the following general formula (B)-1 may also be included alone or in admixture.

N(X)ₙ(Y)₃₋ₙ (B)-1

In the formula, n is equal to 1, 2 or 3; side chain Y is independently hydrogen or a straight, branched or cyclic alkyl group of 1 to 20 carbon atoms which may contain an ether or hydroxyl group; and side chain X is independently selected from groups of the following general formulas (X)-1 to (X)-3, and two or three X's may bond together to form a ring.

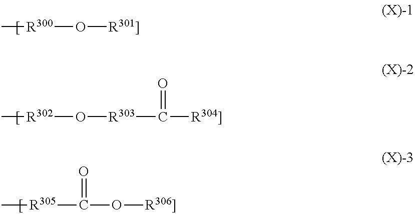

In the formulas, R³⁰⁰, R³⁰² and R³⁰⁵ are independently straight or branched alkylene groups of 1 to 4 carbon atoms; R³⁰¹ and R³⁰⁴ are independently hydrogen, straight, branched or cyclic alkyl groups of 1 to 20 carbon atoms, which may contain at least one hydroxyl, ether, ester group or lactone ring; R³⁰³ is a single bond or a straight or branched alkylene group of 1 to 4 carbon atoms; and R³⁰⁶ is a straight, branched or cyclic alkyl group of 1 to 20 carbon atoms, which may contain at least one hydroxyl, ether, ester group or lactone ring.

Illustrative examples of the compounds of formula (B)-1 include tris(2-methoxymethoxyethyl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5,1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]-ethylamine, N,N-bis(2-acetoxyethyl)-2-[(methoxycarbonyl)methoxycarbonyl]-ethylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(tetrahydrofurfuryloxycarbonyl)-ethylamine, N,N-bis(2-acetoxyethyl)-2-(tetrahydrofurfuryloxycarbonyl)-ethylamine, N,N-bis(2-hydroxyethyl)-2-[(2-oxotetrahydrofuran-3-yl)oxy-carbonyl]ethylamine, N,N-bis(2-acetoxyethyl)-2-[(2-oxotetrahydrofuran-3-yl)oxy-carbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)-ethylamine, N,N-bis(2-formyloxyethyl)-2-(2-formyloxyethoxycarbonyl)-ethylamine, N,N-bis(2-methoxyethyl)-2-(methoxycarbonyl)ethylamine, N-(2-hydroxyethyl)-bis[2-(methoxycarbonyl)ethyl]amine, N-(2-acetoxyethyl)-bis[2-(methoxycarbonyl)ethyl]amine, N-(2-hydroxyethyl)-bis[2-(ethoxycarbonyl)ethyl]amine, N-(2-acetoxyethyl)-bis[2-(ethoxycarbonyl)ethyl]amine, N-(3-hydroxy-1-propyl)-bis[2-(methoxycarbonyl)ethyl]amine, N-(3-acetoxy-1-propyl)-bis[2-(methoxycarbonyl)ethyl]amine, N-(2-methoxyethyl)-bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexyl-bis(methoxycarbonylmethyl)amine, and β-(diethylamino)-δ-valerolactone.

Also useful are one or more organic nitrogen-containing compounds having cyclic structure represented by the following general formula (B)-2.

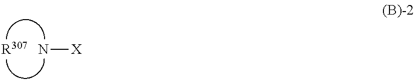

Herein X is as defined above, and R³⁰⁷ is a straight or branched alkylene group of 2 to 20 carbon atoms which may contain one or more carbonyl, ether, ester or sulfide groups.

Illustrative examples of the organic nitrogen-containing compounds having formula (B)-2 include
1-[2-(methoxymethoxy)ethyl]pyrrolidine,
1-[2-(methoxymethoxy)ethyl]piperidine,
4-[2-(methoxymethoxy)ethyl]morpholine,
1-[2-[(2-methoxyethoxy)methoxy]ethyl]pyrrolidine,
1-[2-[(2-methoxyethoxy)methoxy]ethyl]piperidine,
4-[2-[(2-methoxyethoxy)methoxy]ethyl]morpholine,
2-(1-pyrrolidinyl)ethyl acetate, 2-piperidinoethyl acetate,
2-morpholinoethyl acetate, 2-(1-pyrrolidinyl)ethyl formate,
2-piperidinoethyl propionate,
2-morpholinoethyl acetoxyacetate,
2-(1-pyrrolidinyl)ethyl methoxyacetate,
4-[2-(methoxycarbonyloxy)ethyl]morpholine,
1-[2-(t-butoxycarbonyloxy)ethyl]piperidine,
4-[2-(2-methoxyethoxycarbonyloxy)ethyl]morpholine,
methyl 3-(1-pyrrolidinyl)propionate,
methyl 3-piperidinopropionate, methyl 3-morpholinopropionate,
methyl 3-(thiomorpholino)propionate,
methyl 2-methyl-3-(1-pyrrolidinyl)propionate,
ethyl 3-morpholinopropionate,
methoxycarbonylmethyl 3-piperidinopropionate,
2-hydroxyethyl 3-(1-pyrrolidinyl)propionate,
2-acetoxyethyl 3-morpholinopropionate,
2-oxotetrahydrofuran-3-yl 3-(1-pyrrolidinyl)propionate,
tetrahydrofurfuryl 3-morpholinopropionate,
glycidyl 3-piperidinopropionate,
2-methoxyethyl 3-morpholinopropionate,
2-(2-methoxyethoxy)ethyl 3-(1-pyrrolidinyl)propionate,
butyl 3-morpholinopropionate,
cyclohexyl 3-piperidinopropionate,
α-(1-pyrrolidinyl)methyl-γ-butyrolactone,
β-piperidino-γ-butyrolactone, β-morpholino-δ-valerolactone,
methyl 1-pyrrolidinylacetate, methyl piperidinoacetate,
methyl morpholinoacetate, methyl thiomorpholinoacetate,
ethyl 1-pyrrolidinylacetate, 2-methoxyethyl morpholinoacetate,
2-morpholinoethyl 2-methoxyacetate,
2-morpholinoethyl 2-(2-methoxyethoxy)acetate,
2-morpholinoethyl 2-[2-(2-methoxyethoxy)ethoxy]acetate,
2-morpholinoethyl hexanoate, 2-morpholinoethyl octanoate,
2-morpholinoethyl decanoate, 2-morpholinoethyl laurate,
2-morpholinoethyl myristate, 2-morpholinoethyl palmitate, and
2-morpholinoethyl stearate.

Also, one or more organic nitrogen-containing compounds having cyano group represented by the following general formulae (B)-3 to (B)-6 may be blended.

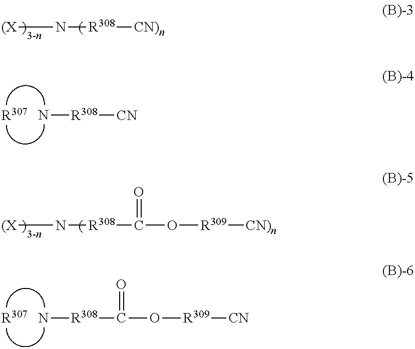

Herein, X, R³⁰⁷ and n are as defined above, and R³⁰⁸ and R³⁰⁹ are each independently a straight or branched alkylene group of 1 to 4 carbon atoms.

Illustrative examples of the organic nitrogen-containing compounds having cyano represented by formulae (B)-3 to (B)-6 include
3-(diethylamino)propiononitrile,
N,N-bis(2-hydroxyethyl)-3-aminopropiononitrile,
N,N-bis(2-acetoxyethyl)-3-aminopropiononitrile,
N,N-bis(2-formyloxyethyl)-3-aminopropiononitrile,
N,N-bis(2-methoxyethyl)-3-aminopropiononitrile,
N,N-bis[2-(methoxymethoxy)ethyl]-3-aminopropiononitrile,
methyl N-(2-cyanoethyl)-N-(2-methoxyethyl)-3-aminopropionate,
methyl N-(2-cyanoethyl)-N-(2-hydroxyethyl)-3-aminopropionate,
methyl N-(2-acetoxyethyl)-N-(2-cyanoethyl)-3-aminopropionate,
N-(2-cyanoethyl)-N-ethyl-3-aminopropiononitrile,
N-(2-cyanoethyl)-N-(2-hydroxyethyl)-3-aminopropiononitrile,
N-(2-acetoxyethyl)-N-(2-cyanoethyl)-3-aminopropiononitrile,
N-(2-cyanoethyl)-N-(2-formyloxyethyl)-3-aminopropiononitrile,
N-(2-cyanoethyl)-N-(2-methoxyethyl)-3-aminopropiononitrile,
N-(2-cyanoethyl)-N-[2-(methoxymethoxy)ethyl]-3-aminopropiono-nitrile,
N-(2-cyanoethyl)-N-(3-hydroxy-1-propyl)-3-aminopropiono-nitrile,
N-(3-acetoxy-1-propyl)-N-(2-cyanoethyl)-3-aminopropiono-nitrile,
N-(2-cyanoethyl)-N-(3-formyloxy-1-propyl)-3-aminopropiono-nitrile,
N-(2-cyanoethyl)-N-tetrahydrofurfuryl-3-aminopropiononitrile,
N,N-bis(2-cyanoethyl)-3-aminopropiononitrile,
diethylaminoacetonitrile,
N,N-bis(2-hydroxyethyl)aminoacetonitrile,
N,N-bis(2-acetoxyethyl)aminoacetonitrile,
N,N-bis(2-formyloxyethyl)aminoacetonitrile,
N,N-bis(2-methoxyethyl)aminoacetonitrile,
N,N-bis[2-(methoxymethoxy)ethyl]aminoacetonitrile,
methyl N-cyanomethyl-N-(2-methoxyethyl)-3-aminoproplonate,
methyl N-cyanomethyl-N-(2-hydroxyethyl)-3-aminopropionate,
methyl N-(2-acetoxyethyl)-N-cyanomethyl-3-aminopropionate,
N-cyanomethyl-N-(2-hydroxyethyl)aminoacetonitrile,
N-(2-acetoxyethyl)-N-(cyanomethyl)aminoacetonitrile,
N-cyanomethyl-N-(2-formyloxyethyl)aminoacetonitrile,
N-cyanomethyl-N-(2-methoxyethyl)aminoacetonitrile,
N-cyanomethyl-N-(2-(methoxymethoxy)ethyl)aminoacetonitrile,
N-cyanomethyl-N-(3-hydroxy-1-propyl)aminoacetonitrile,
N-(3-acetoxy-1-propyl)-N-(cyanomethyl)aminoacetonitrile,
N-cyanomethyl-N-(3-formyloxy-1-propyl)aminoacetonitrile,
N,N-bis(cyanomethyl)aminoacetonitrile,
1-pyrrolidinepropiononitrile, 1-piperidineproplononitrile,
4-morpholinepropiononitrile, 1-pyrrolidineacetonitrile,
1-piperidineacetonitrile, 4-morpholineacetonitrile,
cyanomethyl 3-diethylaminopropionate,
cyanomethyl N,N-bis(2-hydroxyethyl)-3-aminopropionate,
cyanomethyl N,N-bis(2-acetoxyethyl)-3-aminopropionate,
cyanomethyl N,N-bis(2-formyloxyethyl)-3-aminopropionate,
cyanomethyl N,N-bis(2-methoxyethyl)-3-aminopropionate,
cyanomethyl N,N-bis[2-(methoxymethoxy)ethyl]-3-aminopropionate,
2-cyanoethyl 3-diethylaminopropionate,
2-cyanoethyl N,N-bis(2-hydroxyethyl)-3-aminopropionate,
2-cyanoethyl N,N-bis(2-acetoxyethyl)-3-aminopropionate,
2-cyanoethyl N,N-bis(2-formyloxyethyl)-3-aminopropionate,
2-cyanoethyl N,N-bis(2-methoxyethyl)-3-aminopropionate,
2-cyanoethyl N,N-bis[2-(methoxymethoxy)ethyl]-3-amino-propionate,
cyanomethyl 1-pyrrolidinepropionate,
cyanomethyl 1-piperidinepropionate,
cyanomethyl 4-morpholineproplonate,
2-cyanoethyl 1-pyrrolidinepropionate,
2-cyanoethyl 1-piperidinepropionate, and
2-cyanoethyl 4-morpholinepropionate.

Also included are organic nitrogen-containing compounds having an imidazole structure and a polar functional group, represented by the general formula (B)-7.

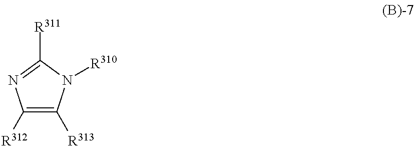

Herein, R³¹⁰ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹¹, R³¹² and R³¹³ are each independently a hydrogen atom, a straight, branched or cyclic alkyl group, aryl group or aralkyl group having 1 to 10 carbon atoms.

Also included are organic nitrogen-containing compounds having a benzimidazole structure and a polar functional group, represented by the general formula (B)-8.

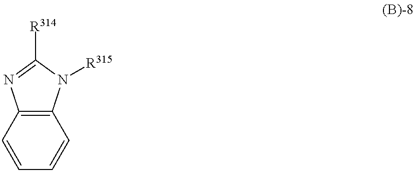

Herein, R³¹⁴ is a hydrogen atom, a straight, branched or cyclic alkyl group, aryl group or aralkyl group having 1 to 10 carbon atoms. R³¹⁵ is a polar functional group-bearing, straight, branched or cyclic alkyl group of 1 to 20 carbon atoms, and the alkyl group contains as the polar functional group at least one group selected from among ester, acetal and cyano groups, and may additionally contain at least one group selected from among hydroxyl, carbonyl, ether, sulfide and carbonate groups.

Further included are heterocyclic nitrogen-containing compounds having a polar functional group, represented by the general formulae (B)-9 and (B)-10.

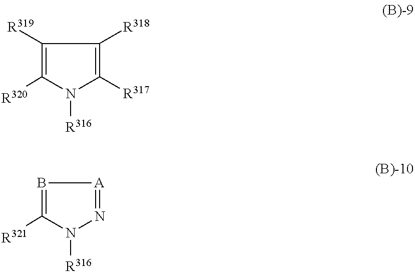

Herein, A is a nitrogen atom or ≡C—R³²², B is a nitrogen atom or ≡C—R³²³, R³¹⁶ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹⁷, R³¹⁸, R³¹⁹ and R³²⁰ are each independently a hydrogen atom, a straight, branched or cyclic alkyl group or aryl group having 1 to 10 carbon atoms, or a pair of R³¹⁷ and R³¹⁸ and a pair of R³¹⁹ and R³²⁰, taken together, may form a benzene, naphthalene or pyridine ring; R³²¹ is a hydrogen atom, a straight, branched or cyclic alkyl group or aryl group having 1 to 10 carbon atoms; R³²² and R³²³ each are a hydrogen atom, a straight, branched or cyclic alkyl group or aryl group having 1 to 10 carbon atoms, or a pair of R³²¹ and R³²³, taken together, may form a benzene or naphthalene ring.

Also included are organic nitrogen-containing compounds of aromatic carboxylic ester structure having the general formulae (B)-11 to (B)-14.

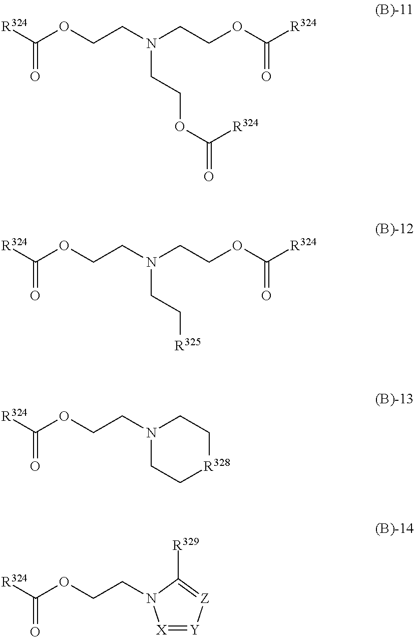

Herein R³²⁴ is a C₆-C₂₀ aryl group or C₄-C₂₀ hetero-aromatic group, in which some or all of hydrogen atoms may be replaced by halogen atoms, straight, branched or cyclic C₁-C₂₀ alkyl groups, C₆-C₂₀ aryl groups, C₇-C₂₀ aralkyl groups, C₁-C₁₀ alkoxy groups, C₁-C₁₀ acyloxy groups or C₁-C₁₀ alkylthio groups. R³²⁵ is CO₂R³²⁶, OR³²⁷ or cyano group. R³²⁶ is a C₁-C₁₀ alkyl group, in which some methylene groups may be replaced by oxygen atoms. R³²⁷ is a C₁-C₁₀ alkyl or acyl group, in which some methylene groups may be replaced by oxygen atoms. R³²⁸ is a single bond, methylene, ethylene, sulfur atom or —O(CH₂CH₂O)ₙ— group wherein n is 0, 1, 2, 3 or 4. R³²⁹ is hydrogen, methyl, ethyl or phenyl. X is a nitrogen atom or CR³³⁰. Y is a nitrogen atom or CR³³¹. Z is a nitrogen atom or CR³³². R³³⁰, R³³¹ and R³³² are each independently hydrogen, methyl or phenyl. Alternatively, a pair of R³³⁰ and R³³¹ or a pair of R³³¹ and R³³² may bond together to form a C₆-C₂₀ aromatic ring or C₂-C₂₀ hetero-aromatic ring.

Further included are organic nitrogen-containing compounds of 7-oxanorbornane-2-carboxylic ester structure having the general formula (B)-15.

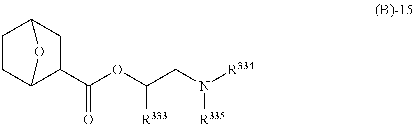

Herein R³³³ is hydrogen or a straight, branched or cyclic C₁-C₁₀ alkyl group. R³³⁴ and R³³⁵ are each independently a C₁-C₂₀ alkyl group, C₆-C₂₀ aryl group or C₇-C₂₀ aralkyl group, which may contain one or more polar functional groups selected from among ether, carbonyl, ester, alcohol, sulfide, nitrile, amine, imine, and amide and in which some hydrogen atoms may be replaced by halogen atoms. R³³⁴ and R³³⁵, taken together, may form a heterocyclic or hetero-aromatic ring of 2 to 20 carbon atoms.

The organic nitrogen-containing compounds may be used alone or in admixture of two or more. The organic nitrogen-containing compound is preferably formulated in an amount of 0.001 to 4 parts, and especially 0.01 to 2 parts by weight, per 100 parts by weight of the entire base resin. Less than 0.001 part of the nitrogen-containing compound achieves no or little addition effect whereas more than 4 parts would result in too low a sensitivity.

The resist composition of the invention may include optional ingredients, for example, a surfactant which is commonly used for improving the coating characteristics. Optional ingredients may be added in conventional amounts so long as this does not compromise the objects of the invention.

Nonionic surfactants are preferred, examples of which include perfluoroalkylpolyoxyethylene ethanols, fluorinated alkyl esters, perfluoroalkylamine oxides, perfluoroalkyl EO-addition products, and fluorinated organosiloxane compounds. Useful surfactants are commercially available under the trade names Fluorad FC-430 and FC-431 from Sumitomo 3M, Ltd., Surflon S-141, S-145, KH-10, KH-20, KH-30 and KH-40 from Asahi Glass Co., Ltd., Unidyne DS-401, DS-403 and DS-451 from Daikin Industry Co., Ltd., Megaface F-8151 from Dai-Nippon Ink & Chemicals, Inc., and X-70-092 and X-70-093 from Shin-Etsu Chemical Co., Ltd. Preferred surfactants are Fluorad FC-430 from Sumitomo 3M, Ltd., KH-20 and KH-30 from Asahi Glass Co., Ltd., and X-70-093 from Shin-Etsu Chemical Co., Ltd.

While the resist composition of the invention typically comprises a polymer, acid generator, organic solvent and organic nitrogen-containing compound as described above, there may be added optional other ingredients such as dissolution inhibitors, acidic compounds, stabilizers, and dyes. Optional ingredients may be added in conventional amounts so long as this does not compromise the objects of the invention.

The constituents used in the invention have been described. For some of the above-described structures, there can exist enantiomers and diastereomers. The structural formula illustrated collectively represents all such stereoisomers. Such stereoisomers may be used alone or in admixture.

Pattern formation using the resist composition of the invention may be carried out by a known lithographic technique. For example, the resist composition is applied onto a substrate such as a silicon wafer by spin coating or the like to form a resist film having a thickness of 0.1 to 2.0 μm, which is then pre-baked on a hot plate at 60 to 150° C. for 1 to 10 minutes, and preferably at 80 to 140° C. for 1 to 5 minutes. A patterning mask having the desired pattern is then placed over the resist film, and the film exposed through the mask to an electron beam or to high-energy radiation such as deep-UV rays, an excimer laser, or x-rays in a dose of about 1 to 200 mJ/cm², and preferably about 10 to 100 mJ/cm². Light exposure may be done by a conventional exposure process or in some cases, by an immersion process of providing liquid (typically water) impregnation between the lens and the resist. The resist film is then post-exposure baked (PEB) on a hot plate at 60 to 150° C. for 1 to 5 minutes, and preferably at 80 to 140° C. for 1 to 3 minutes. Finally, development is carried out using as the developer an aqueous alkali solution, such as a 0.1 to 5 wt % (preferably 2 to 3 wt %) aqueous solution of tetramethylammonium hydroxide (TMAH), this being done by a conventional method such as dip, puddle, or spray development for a period of 0.1 to 3 minutes, and preferably 0.5 to 2 minutes. These steps result in the formation of the desired pattern on the substrate. Of the various types of high-energy radiation that may be used, the resist composition of the invention is best suited to fine pattern formation with, in particular, deep-UV rays having a wavelength of 250 to 190 nm, an excimer laser, x-rays, or an electron beam. The desired pattern may not be obtainable outside the upper and lower limits of the above range.

### EXAMPLE

Synthesis Examples and Examples are given below by way of illustration and not by way of limitation. The abbreviation Mw is a weight average molecular weight as measured by GPC using polystyrene standards; PGMEA is propylene glycol monomethyl ether acetate; and AIBN is 2,2′-azobisisobutyronitrile.

Polymers were synthesized according to the following formulation.

### Example 1

### Synthesis (1) of Polymer 1

In a flask with a nitrogen atmosphere, 55.6 g of 2-methyl-2-adamantyl methacrylate, 44.4 g of 9-methoxycarbonyl-4-oxatricyclo[4.2.1.0^{3,7}]nonan-5-on-2-yl methacrylate, 4.556 g of dimethyl 2,2′-azobis(2-methyl-propionate), 0.289 g of octanethiol as a chain transfer agent, and 200 g of PGMEA were admitted to form a monomer solution. In another flask with a nitrogen atmosphere, 100.0 g of PGMEA and 0.579 g of octanethiol were admitted and heated at 80° C. with stirring, to which the monomer solution kept at 25-30° C. was added dropwise over 5 hours. After the completion of dropwise addition, the polymerization solution was stirred for a further 2 hours while keeping its temperature at 80° C. and then cooled to room temperature. The polymerization solution was added dropwise to 1,600 g of methanol, whereupon the precipitated polymer was collected by filtration. The polymer was washed with 800 g of methanol and again with 400 g of methanol, and vacuum dried at 50° C. for 20 hours, obtaining the polymer in white powder solid form. The polymer was dissolved in PGMEA to form a polymer solution having a concentration of 15 wt %. The solution was passed through a ultra-high molecular weight polyethylene (UPE) filter having a pore diameter of 0.03 μm, giving a polymer solution for resist use. It is noted that the polymer had a Mw of 6,100 and a dispersity (Mw/Mn) of 1.68 as measured by GPC using polystyrene standards. On ¹³C-NMR analysis of the powder polymer as dried after methanol washing, the polymer had a copolymer composition ratio of 56/44 mol % in the described sequence of monomers.

### Example 2

### Synthesis (1) of Polymer 2

In a flask with a nitrogen atmosphere, 34.0 g of 3-ethyl-3-exo-tetracyclo[4.4.0.1^{2,5}.1^{7,10}]dodecanyl methacrylate, 24.4 g of 3-hydroxy-1-adamantyl methacrylate, 41.6 g of 4,8-dioxatricyclo[4.2.1.0^{3,7}]nonan-5-on-2-yl methacrylate, 0.677 g of AIBN, 0.484 g of 2-mercaptoethanol as a chain transfer agent, 93.8 g of PGMEA, and 106.2 g of γ-butyrolactone were admitted to form a monomer solution. In another flask with a nitrogen atmosphere, 46.9 g of PGMEA, 53.1 g of γ-butyrolactone, and 0.403 g of 2-mercaptoethanol were admitted and heated at 80° C. with stirring, to which the monomer solution kept at 20-25° C. was added dropwise over 4 hours. After the completion of dropwise addition, the polymerization solution was stirred for a further 2 hours while keeping its temperature at 80° C. and then cooled to room temperature. The polymerization solution was added dropwise to 1,600 g of methanol, whereupon the precipitated polymer was collected by filtration. The polymer was washed with 600 g of methanol and again with 600 g of methanol. PGMEA was added to the polymer, which was heated in vacuum for distilling off methanol, whereby the polymer was dissolved in PGMEA to form a polymer solution having a concentration of 15 wt %. The solution was passed through a UPE filter having a pore diameter of 0.03 μm, giving a polymer solution for resist use. It is noted that the polymer had a Mw of 8,400 and a dispersity (Mw/Mn) of 1.76 as measured by GPC. A powder polymer was obtained by taking a portion from the polymer after the methanol washing and vacuum drying at 50° C. for 20 hours, and analyzed by ¹³C-NMR, finding a copolymer composition ratio of 26/26/48 mol % in the described sequence of monomers.

### Example 3

### Synthesis (2) of Polymer 2

In a flask with a nitrogen atmosphere, 34.0 g of 3-ethyl-3-exo-tetracyclo[4.4.0.1^{2,5}.1^{7,10}]dodecanyl methacrylate, 24.4 g of 3-hydroxy-1-adamantyl methacrylate, 41.6 g of 4,8-dioxatricyclo[4.2.1.0^{3,7}]nonan-5-on-2-yl methacrylate, 89.1 g of PGMEA, and 100.9 g of γ-butyrolactone were admitted to form a monomer solution. In another flask with a nitrogen atmosphere, 0.677 g of AIBN, 0.484 g of 2-mercaptoethanol as a chain transfer agent, 4.69 g of PGMEA, and 5.31 g of γ-butyrolactone were admitted to form an initiator solution. In a further flask with a nitrogen atmosphere, 0.403 g of 2-mercaptoethanol, 46.9 g of PGMEA, and 53.1 g of γ-butyrolactone were admitted and heated at 80° C. with stirring, to which the monomer solution kept at 45-50° C. and the initiator solution kept at 20-25° C. were separately added dropwise over 4 hours for each.

This was followed by the same procedure as in Example 2, obtaining a polymer solution having a concentration of 15 wt % in PGMEA. The polymer had a Mw of 8,200 and a dispersity (Mw/Mn) of 1.75 as measured by GPC. A powder polymer was obtained by taking a portion from the polymer after the methanol washing and vacuum drying at 50° C. for 20 hours, and analyzed by ¹³C-NMR, finding a copolymer composition ratio of 26/26/48 mol % in the described sequence of monomers.

### Example 4

### Synthesis (1) of Polymer 3

In a flask with a nitrogen atmosphere, 28.7 g of 3-ethyl-3-exo-tetracyclo[4.4.0.1^{2,5}.1^{7,10}]dodecanyl methacrylate, 23.2 g of 3-hydroxy-1-adamantyl acrylate, 44.5 g of 9-methoxycarbonyl-4-oxatricyclo[4.2.1.0^{3,7}]nonan-5-on-2-yl acrylate, 3.60 g of methacrylic acid, and 166.68 g of methyl ethyl ketone (MEK) were admitted to form a monomer solution. In another flask with a nitrogen atmosphere, 2.745 g of AIBN, 0.327 g of 2-mercaptoethanol as a chain transfer agent, and 25.0 g of MEK was admitted to form an initiator solution. In a further flask with a nitrogen atmosphere, 0.163 g of 2-mercaptoethanol and 58.33 g of MEK were admitted and heated at 80° C. with stirring, to which the monomer solution kept at 45-50° C. and the initiator solution kept at 20-25° C. were separately added dropwise over 4 hours for each. After the completion of dropwise addition, the polymerization solution was stirred for a further 2 hours while keeping its temperature at 80° C., and then cooled to room temperature. The polymerization solution was added dropwise to 1,000 g of hexane, whereupon the precipitated polymer was collected by filtration. The polymer was washed with a solvent mixture of 180 g MEK/720 g hexane and again with a solvent mixture of 180 g MEK/720 g hexane. PGMEA was added to the polymer, which was heated in vacuum for distilling off MEK and hexane, whereby the polymer was dissolved in PGMEA to form a polymer solution having a concentration of 15 wt %. The solution was passed through a UPE filter having a pore diameter of 0.03 μm, giving a polymer solution for resist use. It is noted that the polymer had a Mw of 6,800 and a dispersity (Mw/Mn) of 2.14 as measured by GPC. A powder polymer was obtained by taking a portion from the polymer after the MEK/hexane washing and vacuum drying at 50° C. for 20 hours, and analyzed by ¹³C-NMR, finding a copolymer composition ratio of 27/25/39/9 mol % in the described sequence of monomers.

### Comparative Example 1

### Synthesis (2) of Polymer 1

In a flask with a nitrogen atmosphere, 55.6 g of 2-methyl-2-adamantyl methacrylate, 44.4 g of 9-methoxycarbonyl-4-oxatricyclo[4.2.1.0^{3,7}]nonan-5-on-2-yl methacrylate, 4.556 g of dimethyl 2,2′-azobis(2-methyl-propionate), 0.787 g of octanethiol as a chain transfer agent, and 200 g of PGMEA were admitted to form a monomer solution. In another flask with a nitrogen atmosphere, 100.0 g of PGMEA was admitted and heated at 80° C. with stirring, to which the monomer solution kept at 25-30° C. was added dropwise over 5 hours.

This was followed by the same procedure as in Example 1, obtaining a polymer solution having a concentration of 15 wt % in PGMEA. The polymer had a Mw of 6,000 and a dispersity (Mw/Mn) of 1.66 as measured by GPC. On ¹³C-NMR analysis of the powder polymer as dried after methanol washing, the polymer had a copolymer composition ratio of 56/44 mol % in the described sequence of monomers.

### Comparative Example 2

### Synthesis (3) of Polymer 2

In a flask with a nitrogen atmosphere, 34.0 g of 3-ethyl-3-exo-tetracyclo[4.4.0.1^{2,5}.1^{7,10}]dodecanyl methacrylate, 24.4 g of 3-hydroxy-1-adamantyl methacrylate, 41.6 g of 4,8-dioxatricyclo[4.2.1.0^{3,7}]nonan-5-on-2-yl methacrylate, 89.1 g of PGMEA, and 100.9 g of γ-butyrolactone were admitted to form a monomer solution. In another flask with a nitrogen atmosphere, 0.677 g of AIBN, 0.806 g of 2-mercaptoethanol as a chain transfer agent, 4.69 g of PGMEA, and 5.31 g of γ-butyrolactone were admitted to form an initiator solution. In a further flask with a nitrogen atmosphere, 46.9 g of PGMEA and 53.1 g of γ-butyrolactone were admitted and heated at 80° C. with stirring, to which the monomer solution kept at 45-50° C. and the initiator solution kept at 20-25° C. were separately added dropwise over 4 hours for each.

This was followed by the same procedure as in Example 2, obtaining a polymer solution having a concentration of 15 wt % in PGMEA. The polymer had a Mw of 8,300 and a dispersity (Mw/Mn) of 1.72 as measured by GPC. A powder polymer was obtained by taking a portion from the polymer after the methanol washing and vacuum drying at 50° C. for 20 hours, and analyzed by ¹³C-NMR, finding a copolymer composition ratio of 26/26/48 mol % in the described sequence of monomers.

### Comparative Example 3

### Synthesis (2) of Polymer 3

In a flask with a nitrogen atmosphere, 28.7 g of 3-ethyl-3-exo-tetracyclo[4.4.0.1^{2,5}.1^{7,10}]dodecanyl methacrylate, 23.2 g of 3-hydroxy-1-adamantyl acrylate, 44.5 g of 9-methoxycarbonyl-4-oxatricyclo[4.2.1.0^{3,7}]nonan-5-on-2-yl acrylate, 3.60 g of methacrylic acid, and 166.68 g of MEK were admitted to form a monomer solution. In another flask with a nitrogen atmosphere, 2.745 g of AIBN, 0.445 g of 2-mercaptoethanol as a chain transfer agent, and 25.0 g of MEK was admitted to form an initiator solution. In a further flask with a nitrogen atmosphere, 58.33 g of MEK was admitted and heated at 80° C. with stirring, to which the monomer solution kept at 45-50° C. and the initiator solution kept at 20-25° C. were separately added dropwise over 4 hours for each.

This was followed by the same procedure as in Example 4, obtaining a polymer solution having a concentration of 15 wt % in PGMEA. The polymer had a Mw of 6,600 and a dispersity (Mw/Mn) of 2.11 as measured by GPC. A powder polymer was obtained by taking a portion from the polymer after the MEK/hexane washing and vacuum drying at 50° C. for 20 hours, and analyzed by ¹³C-NMR, finding a copolymer composition ratio of 27/25/39/9 mol % in the described sequence of monomers.

### Examples 5 to 8 and Comparative Examples 4 to 6

Resist compositions containing the polymers of the invention were evaluated as follows.

Resist compositions were prepared by using polymers of Examples 1 to 4 or polymers of Comparative Examples 1 to 3 as the base resin, and dissolving the polymer, a photoacid generator, and a organic nitrogen-containing compound in a solvent in accordance with the recipe shown in Tables 1 and 2. These compositions were each filtered through a Teflon® filter having a pore diameter 0.2 μm.

The number of particles having a size of 0.18 μn or greater in the resist composition thus prepared was counted using a particle counter KS-41 by Lyon Co., Ltd. Particle count was performed two times, immediately after preparation and after storage for 30 days at 0° C.

Each of the resist compositions was spin coated on a 8-inch silicon wafer having an antireflective coating (ARC-29A, Nissan Chemical Co., Ltd.) of 78 nm thick and baked at 130° C. for 60 seconds, forming a resist film of 300 nm thick. The wafer was exposed by means of an ArF excimer laser stepper (Nikon Corp., NA 0.68), heat treated (PEB) at 110° C. for 60 seconds, and puddle developed with a 2.38 wt % tetramethylammonium hydroxide aqueous solution for 60 seconds, forming a 0.12-μm line-and-space pattern over the entire wafer surface. The wafer was evaluated for development defects by counting the number of defects with a flaw detector WIN-WIN50 1200L (Tokyo Seimitsu Co., Ltd.). Defect count was also performed two times, immediately after preparation and after storage for 30 days at 0° C.

Reported in Tables 1 and 2 are the number of particles and the number of defects on the resist films using the polymers of Examples 1 to 4 and Comparative Examples 1 to 3. The acid generator, organic nitrogen-containing compound and solvent in Tables 1 and 2 are identified below. Note that the solvent (PGMEA) contained 0.01 wt % of surfactant KH-20 (Asahi Glass Co., Ltd.).

TPSNF: triphenylsulfonium nonafluorobutanesulfonate
TMMEA: trismethoxymethoxyethylamine
PGMEA: propylene glycol monomethyl ether acetate

TABLE 1

| | | | | | | | | Number of | |
|---|---|---|---|---|---|---|---|---|---|
| | | | | | | Number of | | development | |
| | | | | | | particles | | defects | |
| | | | Nitrogen- | | | (/ml) | | (/wafer) | |
| | Polymer | Acid | containing | | PEB | | After | | After |
| | solution | generator | compound | Solvent | temp. | As | 30 day | As | 30 day |
| Example | (pbw) | (pbw) | (pbw) | (pbw) | (° C.) | prepared | storage | prepared | storage |
| 5 | Synthesized | TPSNF | TMMEA | PGMEA | 110 | 0 | 1 | 5 | 8 |
| | in Example 1 | (2.18) | (0.472) | (187) | | | | | |
| | (533) | | | | | | | | |
| 6 | Synthesized | TPSNF | TMMEA | PGMEA | 110 | 0 | 0 | 3 | 5 |
| | in Example 2 | (2.18) | (0.472) | (187) | | | | | |
| | (533) | | | | | | | | |
| 7 | Synthesized | TPSNF | TMMEA | PGMEA | 110 | 0 | 0 | 2 | 1 |
| | in Example 3 | (2.18) | (0.472) | (187) | | | | | |
| | (533) | | | | | | | | |
| 8 | Synthesized | TPSNF | TMMEA | PGMEA | 110 | 0 | 0 | 2 | 2 |
| | in Example 4 | (2.18) | (0.472) | (187) | | | | | |
| | (533) | | | | | | | | |

TABLE 2

| | | | | | | | | Number of | |
|---|---|---|---|---|---|---|---|---|---|
| | | | | | | Number of | | development | |
| | | | | | | particles | | defects | |
| | | | Nitrogen- | | | (/ml) | | (/wafer) | |
| | Polymer | Acid | containing | | PEB | | After | | After |
| Comparative | solution | generator | compound | Solvent | temp. | As | 30 day | As | 30 day |
| Example | (pbw) | (pbw) | (pbw) | (pbw) | (° C.) | prepared | storage | prepared | storage |
| 4 | Synthesized | TPSNF | TMMEA | PGMEA | 110 | 0 | 15 | 7 | 36 |
| | in | (2.18) | (0.472) | (187) | | | | | |
| | Comparative | | | | | | | | |
| | Example 1 | | | | | | | | |
| | (533) | | | | | | | | |
| 5 | Synthesized | TPSNF | TMMEA | PGMEA | 110 | 0 | 9 | 4 | 25 |
| | in | (2.18) | (0.472) | (187) | | | | | |
| | Comparative | | | | | | | | |
| | Example 2 | | | | | | | | |
| | (533) | | | | | | | | |
| 6 | Synthesized | TPSNF | TMMEA | PGMEA | 110 | 0 | 8 | 3 | 29 |
| | in | (2.18) | (0.472) | (187) | | | | | |
| | Comparative | | | | | | | | |
| | Example 3 | | | | | | | | |
| | (533) | | | | | | | | |

It is seen from Table 2 that in Comparative Examples 4 to 6, the number of particles and the number of development defects increased after storage. This suggests that the resist composition contained a noticeable amount of a substantially insoluble component which grew with the lapse of time.

In contrast, as seen from Table 1, the resist compositions of the invention (Examples 5 to 8) showed no or little increase in the number of particles and the number of development defects after storage. It is believed that this is because the polymers synthesized in Examples 1 to 4 contained a minimal amount of a component which is substantially insoluble in resist solvent.

It is thus evident that the resist compositions using the inventive polymers as a base resin provide a minimized number of defects when processed by photolithography and are effective in forming microscopic patterns.

Japanese Patent Application No. 2006-133797 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1-8. (canceled)

9. A method for preparing a polymer for resist use, comprising the steps of:
previously charging a reactor with a solution containing a chain transfer agent and holding at a polymerization temperature, and
continuously or discontinuously adding dropwise a solution containing at least one monomer and a polymerization initiator to the reactor for radical polymerization.

10. A method for preparing a polymer for resist use, comprising the steps of:
previously charging a reactor with a solution containing a chain transfer agent and holding at a polymerization temperature, and
continuously or discontinuously adding dropwise a solution containing at least one monomer and a solution containing a polymerization initiator separately to the reactor for radical polymerization.

11. The method of claim 9, wherein the chain transfer agent is a thiol compound.

12. The method of claim 11, wherein the chain transfer agent is selected from the group consisting of 1-butanethiol, 2-butanethiol, 2-methyl-1-propanethiol, 1-octanethiol, 1-decanethiol, 1-tetradecanethiol, cyclohexanethiol, 2-mercaptoethanol, 1-mercapto-2-propanol, 3-mercapto-1-propanol, 4-mercapto-1-butanol, 6-mercapto-1-hexanol, 1-thioglycerol, thioglycolic acid, 3-mercaptopropionic acid, and thiolactic acid, and mixtures thereof.

13. The method of claim 9, wherein the polymer prepared by the method comprises recurring units derived from an acid-labile group-containing monomer and recurring units derived from a lactone structure-bearing monomer.

14. The method of claim 10, wherein the chain transfer agent is a thiol compound.

15. The method of claim 14, wherein the chain transfer agent is selected from the group consisting of 1-butanethiol, 2-butanethiol, 2-methyl-1-propanethiol, 1-octanethiol, 1-decanethiol, 1-tetradecanethiol, cyclohexanethiol, 2-mercaptoethanol, 1-mercapto-2-propanol, 3-mercapto-1-propanol, 4-mercapto-1-butanol, 6-mercapto-1-hexanol, 1-thioglycerol, thioglycolic acid, 3-mercaptopropionic acid, and thiolactic acid, and mixtures thereof.

16. The method of claim 10, wherein the polymer prepared by the method comprises recurring units derived from an acid-labile group-containing monomer and recurring units derived from a lactone structure-bearing monomer.

17. The method of claim 13, wherein the acid-labile group-containing monomer has the following general formula (1) and the lactone structure-bearing monomer has the following general monomer (2): 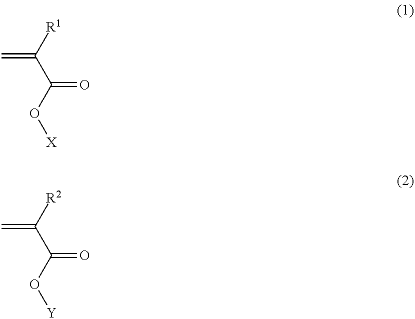
wherein R¹ is hydrogen, fluorine, methyl or trifluoromethyl, X is an acid labile group, R² is hydrogen, fluorine, methyl or trifluoromethyl, and Y is a substituent group having a lactone structure.

18. The method of claim 17, wherein the lactone structure represented Y is selected from groups of the general formulae (A1) to (A9):

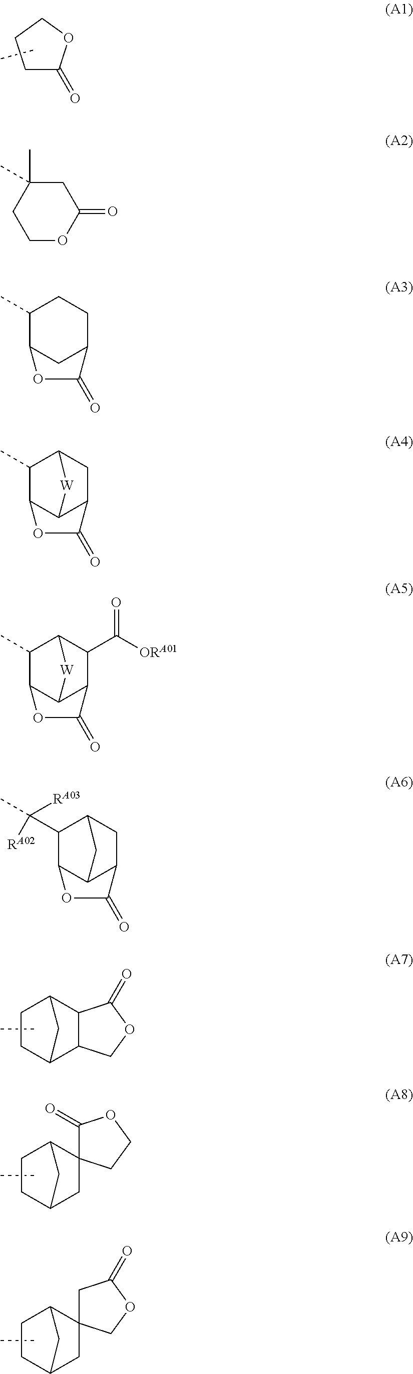

19. The method of claim 13, wherein the polymer further comprises recurring units derived from monomers 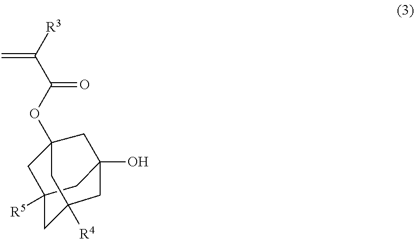
wherein R³ is hydrogen, fluorine, methyl or trifluoromethyl, and R⁴ and R⁵ are each independently hydrogen or hydroxyl.

20. The method of claim 16, wherein the acid-labile group-containing monomer has the following general formula (1) and the lactone structure-bearing monomer has the following general monomer (2): 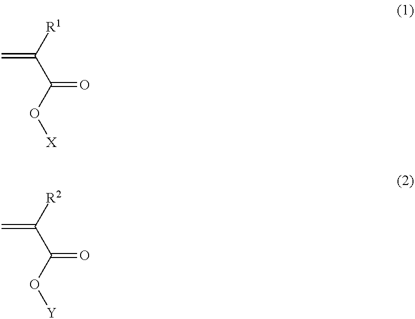
wherein R¹ is hydrogen, fluorine, methyl or trifluoromethyl, X is an acid labile group, R² is hydrogen, fluorine, methyl or trifluoromethyl, and Y is a substituent group having a lactone structure.

21. The method of claim 20, wherein the lactone structure represented Y is selected from groups of the general formulae (A1) to (A9):

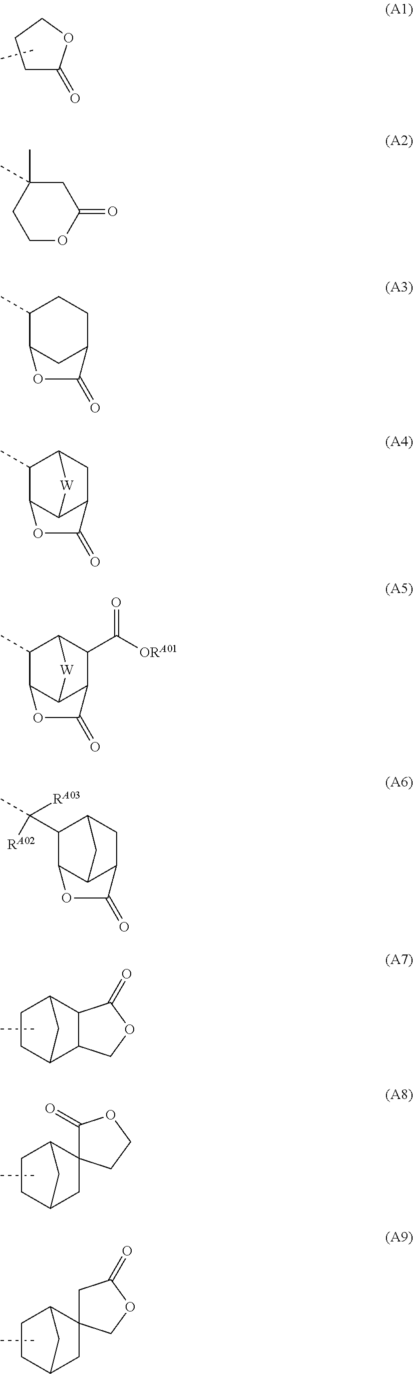

22. The method of claim 16, wherein the polymer further comprises recurring units derived from monomers 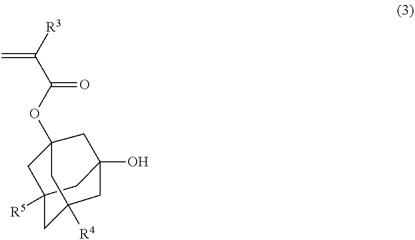
wherein R³ is hydrogen, fluorine, methyl or trifluoromethyl, and R⁴ and R⁵ are each independently hydrogen or hydroxyl.

23. The method of claim 10, wherein the solution containing at least one monomer is preheated to a temperature of 40° C. to less than 70° C., and the temperature of the solution containing a polymerization initiator is equal to or less than 40° C.
